(19) United States
(12) Patent Application Publication
(10) Pub. No.: US 2022/0373645 A1
(43) Pub. Date: Nov. 24, 2022

(54) Sensor Validation and Calibration

(71) Applicant: UATC, LLC, Mountain View, CA (US)

(72) Inventors: Marek Vladimir Travnikar, Mountain View, CA (US); Kyle Lutz, San Francisco, CA (US)

(21) Appl. No.: 17/870,711

(22) Filed: Jul. 21, 2022

Related U.S. Application Data
(63) Continuation of application No. 16/841,047, filed on Apr. 6, 2020.
(60) Provisional application No. 62/990,694, filed on Mar. 17, 2020.

(51) Int. Cl. G01S 7/40; G01S 7/292; G01S 13/42; G01S 13/86; G01S 5/14

(52) U.S. Cl. CPC G01S 7/4082; G01S 7/292; G01S 13/42; G01S 13/867; G01S 13/865; G01S 5/14; G01S 2013/93271

(57) ABSTRACT

Systems, methods, tangible non-transitory computer-readable media, and devices associated with radar validation and calibration are provided. For example, target positions for targets can be determined based on imaging devices. The targets can be located at respective predetermined positions relative to the imaging devices. Radar detections of the targets can be generated based on radar devices. The radar devices can be located at a predetermined position relative to the imaging devices. Filtered radar detections can be generated based on performance of filtering operations on the radar detections. A detection error can be determined for the radar devices based on calibration operations performed using the filtered radar detections and the target positions determined based on the one or more imaging devices. Furthermore, the radar devices can be calibrated based on the detection error.

### RELATED APPLICATION

The present application is based on and claims benefit of U.S. Provisional Patent Application No. 62/990,694 having a filing date of Mar. 17, 2020, which is incorporated by reference herein.

### FIELD

The present disclosure relates generally to the validation and calibration of radar devices.

### BACKGROUND

Vehicles, including autonomous vehicles, can receive data that is used to determine the state of an environment through which the vehicle travels. This data can be associated with various representations of the environment including objects that are present in the environment. As the state of the environment is dynamic, and the objects that are present in the environment can change over time, operation of a vehicle may rely on an accurate determination of the state of the representations of the environment over time.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method of radar calibration. The computer-implemented method can include determining, by a computing system including one or more computing devices, based at least in part on one or more imaging devices, a plurality of target positions for a plurality of targets. The plurality of targets can be located at a respective plurality of predetermined positions relative to the one or more imaging devices. The computer-implemented method can include generating, by the computing system, based at least in part on one or more radar devices, a plurality of radar detections of the plurality of targets. The one or more radar devices can be located at a predetermined position relative to the one or more imaging devices. The computer-implemented method can include generating, by the computing system, a plurality of filtered radar detections based at least in part on performance of one or more filtering operations on the plurality of radar detections. The computer-implemented method can include determining, by the computing system, a detection error for the one or more radar devices based at least in part on one or more calibration operations performed using the plurality of filtered radar detections and the plurality of target positions determined based on the one or more imaging devices. Furthermore, the computer-implemented method can include calibrating, by the computing system, the one or more radar devices based at least in part on the detection error.

Another example aspect of the present disclosure is directed to a computing system including: one or more processors; a memory including one or more computer-readable media, the memory storing computer-readable instructions that when executed by the one or more processors cause the one or more processors to perform operations. The operations can include determining, based at least in part on one or more imaging devices, a plurality of target positions for a plurality of targets. The plurality of targets can be located at a respective plurality of predetermined positions relative to the one or more imaging devices. The operations can include generating, based at least in part on one or more radar devices, a plurality of radar detections of the plurality of targets. The one or more radar devices can be located at a predetermined position relative to the one or more imaging devices. The operations can include generating a plurality of filtered radar detections based at least in part on performance of one or more filtering operations on the plurality of radar detections. The operations can include determining a detection error for the one or more radar devices based at least in part on one or more calibration operations performed using the plurality of filtered radar detections and the plurality of target positions determined based on the one or more imaging devices. Furthermore, the operations can include calibrating the one or more radar devices based at least in part on the detection error.

Another example aspect of the present disclosure is directed to an autonomous vehicle including: one or more processors; a memory including one or more computer-readable media, the memory storing computer-readable instructions that when executed by the one or more processors cause the one or more processors to perform operations. The operations can include determining, based at least in part on one or more imaging devices, a plurality of target positions for a plurality of targets. The plurality of targets can be located at a respective plurality of predetermined positions relative to the one or more imaging devices. The operations can include generating, based at least in part on one or more radar devices, a plurality of radar detections of the plurality of targets. The one or more radar devices can be located at a predetermined position relative to the one or more imaging devices. The operations can include generating a plurality of filtered radar detections based at least in part on performance of one or more filtering operations on the plurality of radar detections. The operations can include determining a detection error for the one or more radar devices based at least in part on one or more calibration operations performed using the plurality of filtered radar detections and the plurality of target positions determined based on the one or more imaging devices. Furthermore, the operations can include calibrating the one or more radar devices based at least in part on the detection error.

Other example aspects of the present disclosure are directed to other systems, methods, vehicles, apparatuses, tangible non-transitory computer-readable media, and devices for radar validation and calibration.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a diagram of an example system according to example embodiments of the present disclosure;

FIG. 2 depicts an example of a technique for radar error measurement according to example embodiments of the present disclosure;

FIG. 3 depicts an example of comparing radar detections of a target according to example embodiments of the present disclosure;

FIG. 4 depicts an example of a target used for radar validation and calibration according to example embodiments of the present disclosure;

FIG. 5 depicts an example of a validation and calibration technique according to example embodiments of the present disclosure;

FIG. 6 depicts a flow diagram of an example of radar validation and calibration according to example embodiments of the present disclosure;

FIG. 7 depicts a flow diagram of an example of radar validation and calibration according to example embodiments of the present disclosure;

FIG. 8 depicts a flow diagram of an example of radar validation and calibration according to example embodiments of the present disclosure;

FIG. 9 depicts a flow diagram of an example of radar validation and calibration according to example embodiments of the present disclosure;

FIG. 10 depicts a flow diagram of an example of radar validation and calibration according to example embodiments of the present disclosure;

FIG. 11 depicts a diagram of an example system according to example embodiments of the present disclosure; and

FIG. 12 depicts a diagram of an example system according to example embodiments of the present disclosure.

### DETAILED DESCRIPTION

Example aspects of the present disclosure are directed to the validation and calibration of radar devices. For example, the disclosed technology can be used to calibrate a radar device based on the comparison of radar detections of targets with fiducial images and radar reflectors, to the detections of the same targets using another type of sensor such as, for example, a camera. Further aspects of the present disclosure include cross-validation of sensor devices that are used as part of the radar device calibration. The technology described herein can be utilized to validate and calibrate radar devices without a “rail” barrier (e.g., a wall or series of objects), which can cause detection error due to, for example, reflection.

The radar devices calibrated by the disclosed technology can be used in a variety of ways, including the validation and calibration of the radar devices used as part of a sensor system of an autonomous vehicle. For example, the disclosed technology can validate and/or calibrate a radar device so that it improves the overall accuracy and/or precision of the radar device. In this way, the disclosed technology can calibrate a radar device in a way that allows for improved object detection in an environment, thereby providing a useful contribution to the safety of vehicle operation.

The disclosed technology can be implemented as a computing system (e.g., a computing system) that is configured to use imaging devices to determine a plurality of target positions for a plurality of targets (e.g., rectangular signs that can be positioned at various distances from the imaging devices and/or radar devices). For example, cameras can be used to determine the position, orientation, and/or identity of targets that include respective fiducial images that can be used as a point of reference and to facilitate determination of the position of the targets. Although some of the present techniques are described herein as being performed within the context of a vehicle computing system, this has been done for illustrative purposes only. The validation and calibration process can be performed by another type of computing system and/or can be remote from the host system (e.g., an autonomous vehicle) that will ultimately utilize the radar devices for environmental perception.

Further, the plurality of targets can be located at a respective plurality of predetermined positions relative to the one or more imaging devices. The different positions of the plurality of targets can be used to determine the accuracy and/or precision of sensors (e.g., radar devices) that are placed at different distances or angles relative to the plurality of targets. The computing system can then use radar devices to generate a plurality of radar detections of the same plurality of targets. The radar devices can be located at various predetermined positions relative to the imaging devices (e.g., the radar devices can be a predetermined distance next to the imaging devices). By locating the radar devices at different distances from the plurality of targets, the accuracy of the radar devices at different distances or angles can be validated and/or calibrated.

The computing system can then generate a plurality of filtered radar detections based at least in part on the performance of one or more filtering operations on the plurality of radar detections. The filtering operations can filter noise from the raw radar detections, thereby generating an input (excluding the noise) that can be used to determine a detection error that is used for calibration of the radar device. After the filtering operations are performed, the computing system can determine a detection error for the radar devices based on calibration operations. The calibration operations can be performed using the plurality of filtered radar detections and the plurality of target positions determined based on the one or more imaging devices. For example, the calibration operations can determine the detection error based at least in part on differences between the expected (actual) target positions and positions determined based on the filtered radar detections. Furthermore, the computing system can calibrate the radar devices based at least in part on the detection error. For example, the detection error can indicate the extent to which a radar device is mis-calibrated which can then be used to calibrate the radar device so that it can more accurately and/or precisely detect objects.

Accordingly, the disclosed technology can improve the effectiveness of radar devices through improved validation and/or calibration. The improvement resulting from more effective calibration of radar devices can allow for a host of improvements in vehicle safety (and the safety of nearby objects) as well as an enhancement in the overall operation of a vehicle and other systems that benefit from well validated and/or calibrated radar devices.

An autonomous vehicle (e.g., ground-based vehicle, bikes, scooters, and/or light electric vehicles) can include various systems and devices configured to control the operation of the vehicle. For example, an autonomous vehicle can include an onboard vehicle computing system (e.g., located on or within the autonomous vehicle) that is configured to operate the autonomous vehicle. Generally, the vehicle computing system can obtain sensor data from a sensor system onboard the vehicle, attempt to comprehend the vehicle's surrounding environment by performing various processing techniques on the sensor data, and generate an appropriate motion plan through the vehicle's surrounding environment. The sensor system can include one or more imaging devices such as, for example, one or more cameras (e.g., optical cameras that can have a variety of focal lengths) and/or one or more light detection and ranging (LiDAR) devices. The sensor system can also include one or more radar devices and/or other sensors.

The radar devices of the autonomous vehicle's sensor suite can be calibrated and/or validated according to the technology described herein to help the vehicle perceive its environment and, ultimately, autonomously plan the vehicle's motion. As part of performing the operations described herein, the computing system can determine a plurality of target positions for a plurality of targets. As further described herein, the targets can include an image (e.g., a fiducial tag, AprilTag, QR code, and/or encoded image) displayed on a surface (e.g., a board or backing) as well as a radar reflector that can be positioned and/or located at a predetermined position or location relative to the image. Determination of the plurality of target positions can be based at least in part on one or more imaging devices. For example, the plurality of target positions can be determined by cameras that detect each target and determine the position (e.g., distance from the camera and/or orientation of the target) based on images (e.g., a fiducial image on the target).

Furthermore, the one or more imaging devices can include one or more cameras (e.g., optical cameras that can have a variety of focal lengths) and/or one or more light detection and ranging (LiDAR) devices.

The plurality of targets can be located at a respective plurality of predetermined positions relative to the one or more imaging devices. For example, the plurality of targets can be arranged so that all of the plurality of targets are visible to the one or more imaging devices and do not obstruct the view of any other targets of the plurality of targets. In some embodiments, the plurality of predetermined positions can be a respective plurality of different distances from the one or more imaging devices. For example, three targets can be located at distances of twenty (20) meters, forty (40) meters, and sixty (60) meters from the one or more imaging devices.

In some embodiments, each of the targets can include one or more fiducial images that identify the respective target. For example, each of the plurality of targets can include an image that uniquely identifies the target and can be associated with other additional information including the size of the target. This can include, for example, a fiducial tag (e.g., AprilTag, QR code) that is encoded with a variety of information.

The plurality of targets can be configured in a variety of ways. A target can include a one or more radar reflectors and one or more images (e.g., fiducial images). The plurality of radar reflectors can include radar reflectors made from a material (e.g., aluminum) and can be configured to reflect radio waves emitted by the one or more radar devices.

In some embodiments, each of the plurality of radar reflectors can be located at a predetermined position relative to a respective fiducial image of the plurality of fiducial images. For example, a radar reflector can be located thirty (30) centimeters directly below the bottom edge of a fiducial image. By locating each of the plurality of radar reflectors at a predetermined position relative to the respective fiducial image, the positions determined using the one or more imaging devices and the one or more radar devices can be more readily compared.

The one or more imaging devices can be cross-validated before being used to calibrate the one or more radar devices. In some embodiments, the one or more imaging devices can include a first imaging device and a second imaging device. For example, the first imaging device and the second imaging device can include a first camera and a second camera. The computing system can determine, based at least in part on the first imaging device, a first set of positions of the plurality of targets. For example, the first camera can be used to determine a first set of positions including the orientations and distances of the plurality of targets from the first camera. The computing system can determine, based at least in part on the second imaging device, a second set of positions of the plurality of targets. For example, the second camera can be used to determine a second set of positions including the orientations and distances of the same plurality of targets that were detected by the first camera. Further, the first imaging device and the second imaging device can be positioned at the same location (e.g., the first imaging device and the second imaging device swap places after capturing images from a predetermined location) or the first imaging device and the second imaging device can be positioned at predetermined locations (e.g., the first imaging device is located five (5) centimeters to the left of the second imaging device).

The computing system can cross-validate the first imaging device and the second imaging device based at least in part on one or more comparisons of the first set of positions to the second set of positions. For example, the computing system can perform one or more comparisons of the target position of a target determined by the first imaging device (e.g., a camera that has various distortion (e.g., radial distortion) and/or aberration (e.g., chromatic aberration) to an expected position of the same target that is determined by a second imaging device (e.g., a LiDAR device that has higher accuracy and/or precision than the camera). The one or more comparisons can be used to determine an amount of imaging error in the first imaging device that can in turn be used to validate the first imaging device.

In some embodiments, the first imaging device can have a different resolution from the second imaging device (e.g., the first imaging device has a lower spatial resolution or spectral resolution than the second imaging device) and/or the first imaging device can be a different type of imaging device than the second imaging device (e.g., the first imaging device is a camera and the second imaging device is a LiDAR device).

The computing system can generate, based at least in part on one or more radar devices, a plurality of radar detections of the plurality of targets. The one or more radar devices can be located at a predetermined position relative to the one or more imaging devices. For example, a radar device can be ten centimeters to the right of an imaging device, or five centimeters above the imaging device.

In some embodiments, generating the plurality of radar detections can include positioning the one or more radar devices in a plurality of different radar device positions relative to the plurality of targets. For example, the plurality of radar devices can be mounted on respective stands that can be adjusted (e.g., moved to different positions and/or orientations) to aim the plurality of radar devices in different directions.

Further, generating the plurality of radar detections can include generating the plurality of radar detections at each of the plurality of different radar device positions. For example, one or more of the plurality of radar detections can be generated at each of the different radar device positions.

The plurality of different radar positions can be associated with positions and/or situations that the one or more radar devices may encounter when being put into practice (e.g., when mounted on a vehicle and used as part of the vehicle's sensor system). In some embodiments, the plurality of different radar positions can include a plurality of orientations of the one or more radar devices or a plurality of heights of the one or more radar devices. For example, each of the one or more radar devices can be mounted on a stand that can be used to change the height and/or orientation of the respective radar device.

In some embodiments, the one or more radar devices can be located on one or more portions of a vehicle (e.g., an autonomous vehicle). For example, the plurality of radar devices can include four radar devices that are located on the front side, rear side, port side (e.g., the left side of the autonomous vehicle from the perspective of a forward facing passenger inside the autonomous vehicle), and starboard side (e.g., the right side of the autonomous vehicle from the perspective of a forward facing passenger inside the autonomous vehicle) of the autonomous vehicle respectively.

In some embodiments, the plurality of targets can be located at different positions around the autonomous vehicle. For example, the plurality of targets can include four targets that are located in front of the autonomous vehicle, to the rear of the autonomous vehicle, on the port side of the autonomous vehicle, and the starboard side of the autonomous vehicle.

In some embodiments, generating the plurality of radar detections can include moving the autonomous vehicle to one or more positions that align the one or more radar devices with the plurality of targets. For example, the plurality of radar detections can include radar detections that were generated by one or more radar devices and can include the range (distance), orientation, and/or velocity of the plurality of targets.

Moving the autonomous vehicle can include rotating the autonomous vehicle. For example, the autonomous vehicle can be placed on a turntable that is configured to rotate the autonomous vehicle to one or more positions. The one or more positions can align the one or more radar devices on the autonomous vehicle with the plurality of targets arranged around the autonomous vehicle.

The computing system can generate a plurality of filtered radar detections based at least in part on the performance of one or more filtering operations on the plurality of radar detections. The one or more filtering operations can include operations that reduce noise that is present in the plurality of radar detections. For example, the one or more filtering operations can reduce the number of filtered radar detections by more than ninety-nine percent (99%), which can result in better determination of detection error due to the removal of invalid radar detections. In some embodiments, the one or more filtering operations can include determining the plurality of radar detections based at least in part on the time at which the plurality of radar detections were performed (e.g., associating each of the plurality of radar detections with a time stamp and using the time stamp to filter the plurality of radar detections based on factors including the position of the sun at a particular time of day that is associated with the respective time stamp), determining a motion of the one or more radar devices (e.g., filtering noise that results from the motion of a vehicle on which the one or more radar devices are mounted), determining a scan mode of the one or more radar devices (e.g., medium or long scan mode), determining an intensity of the radio signal for one or more radar devices (e.g., signal-to-noise ratio and/or radar cross-section), determining a proximity of the one or more radar devices to the plurality of targets, and/or determining a group sparsity of the plurality of radar detections (e.g., how tight/sparse is the density of points).

The computing system can determine a detection error for the one or more radar devices based at least in part on one or more calibration operations performed using the plurality of filtered radar detections and the plurality of target positions determined based on the one or more imaging devices. The one or more calibration operations can include use of an optimizer that receives an input including the plurality of target positions and the plurality of filtered radar detections; performs one or more optimizations associated with minimizing the differences in the positions determined by the plurality of target positions and the plurality of filtered radar detections; and providing an output including a detection error that is associated with an amount of error in the configuration of the one or more radar devices and/or an offset that can be used to reduce that error.

In some embodiments, determining the detection error can include performing one or more optimizations of the input including the plurality of target positions determined based on the one or more imaging devices and the plurality of filtered radar detections. The one or more optimizations can be used to optimize the configuration of the one or more radar devices by performing one or more operations to determine one or more differences between the plurality of target positions and the detected target positions associated with the plurality of filtered radar detections.

In some embodiments, determining the detection error can include minimizing a detection cost associated with one or more configurations of the one or more radar devices and one or more differences between a plurality of expected target positions and corresponding detected target positions associated with the plurality of filtered radar detections. The detection cost can, for example, be associated with a distance (e.g., a distance in millimeters) and/or an angular difference (e.g., a difference in radians or degrees) between an expected target position and the detected target position based on the filtered radar detection. As such, a greater distance between the expected target position and the detected target position can be associated with a greater detection cost. Further, the detection cost can be used to determine one or more position offsets of the one or more radar devices (e.g., an offset from a three-dimensional position of any of the one or more radar devices with respect to some point of reference including some object (e.g., a vehicle) that the one or more radar devices are associated (e.g., attached to) with), one or more yaw offsets of the one or more radar devices, one or more pitch offsets of the one or more radar devices, and/or one or more roll offsets of the one or more radar devices.

For example, the yaw offset can include an amount by which the yaw of the radar device should be adjusted to reduce or eliminate the difference between the plurality of expected target positions and the detected target positions. The yaw offset can then be used to configure a radar device that can be adjusted based at least in part on the detection cost, such that adjustment of the radar device's yaw is proportional to the detection cost (e.g., a greater detection cost is positively correlated with a greater yaw offset). In some embodiments, minimizing the detection cost can include minimization of a detection cost associated with a non-linear least squares function.

Further, determining the detection error can be based at least in part on the detection cost. For example, the detection error can be positively correlated with the detection cost so that a greater detection cost is related to a greater detection error.

In some embodiments, the one or more calibration operations can include minimization of a non-linear least squares function comprising a plurality of parameters associated with the plurality of target positions and the plurality of filtered radar detections. For example, the computing system can perform one or more calibration operations that include minimizing the residual (e.g., a residual associated with a detection cost) associated with the difference between the target position associated with the plurality of filtered radar detections and the plurality of target positions associated with an expected or actual target position (e.g., the actual position (distance and orientation) of a target from the position of a radar device).

The computing system can calibrate the one or more radar devices based at least in part on the detection error. For example, the detection error can be associated with an offset value that can be used to calibrate the one or more radar devices. For example, the detection error can be associated with one or more configurations (e.g., physical configurations and/or software configurations) of the one or more radar devices. Calibrating the one or more radar devices can include adjusting or changing the one or more configurations of any of the one or more radar devices in a way that corresponds with a reduced detection error and/or a detection error that is below some maximum detection error threshold.

In some embodiments, calibrating, by the computing system, the one or more radar devices can include adjusting, modifying, and/or changing one or more positions of the one or more radar devices based at least in part on the detection error. Each of the one or more radar devices Adjusting one or more positions of the one or more radar devices can include changing and/or moving the position of the one or more radar devices and/or one or more devices to which the one or more radar devices are affixed, attached, joined, or mounted. Further, adjusting one or more positions of the one or more radar devices can include adjusting the roll, pitch, and/or yaw of the one or more radar devices. In some embodiments, adjusting one or more positions of the one or more radar devices can include adjusting the location of any of the one or more radar devices including the location (e.g., a three-dimensional location associated with x, y, and z coordinates of a radar device in three-dimensional space) of any of the one or more radar devices with respect to an object. Adjusting the location of the one or more radar devices can include adjusting the location and/or position of any of the one or more radar devices with respect to a vehicle, a mounting stand, and/or any other type of device.

For example, the detection error can indicate that a radar device is mis-calibrated by zero point five (0.5) degrees to the right of a target. Calibrating the radar device can include adjusting the position of the radar device by zero point five (0.5) degrees to the left. By way of further example, adjusting the position of the one or more radar devices can include adjusting a yaw offset of the one or more radar devices.

In some embodiments, calibrating the one or more radar devices can include calibrating the one or more radar devices when the detection error satisfies one or more calibration criteria. Satisfying the one or more calibration criteria can include the detection error exceeding a maximum detection error threshold. For example, the maximum detection error threshold can be associated with an amount of error that is acceptable (reducing the detection error to zero may not be possible or practical). Calibration of the one or more radar devices can then be performed if and/or when the detection error is greater than or equal to the maximum detection error threshold.

The disclosed technology can be implemented by a variety of systems that are configured to validate and/or calibrate radar devices. In particular, the disclosed technology can be used as part of a vehicle (e.g., an autonomous vehicle) that uses radar detections as an input to a perception system that is used in the operation of the vehicle. For example, an autonomous vehicle that receives radar detections from well calibrated radar devices can better detect objects within its environment and maintain an appropriate travel path with respect to pedestrians and other vehicles, thereby navigating the environment with a greater level of safety.

Furthermore, the disclosed technology can include a computing system that is configured to perform various operations associated with the validation and/or calibration of radar devices that can be used to operate a vehicle. In some embodiments, the computing system can be associated with the autonomy system of an autonomous vehicle which can include a perception system, a prediction system, and/or a motion planning system. Furthermore, the computing system can process, generate, modify, and/or access (e.g., send, and/or receive) data and/or information including data and/or information associated with determining the position of targets using imaging devices, generating radar detections using radar devices, filtering the radar detections, determining a detection error, and calibrating the radar devices so that the radar devices can generate improved radar detections that can be used for various purposes including as an input to the autonomy system of an autonomous vehicle.

The systems, methods, devices, and non-transitory computer-readable media in the disclosed technology can provide a variety of technical effects and benefits to the validation and calibration of radar devices, which can be leveraged to improve the overall operation of devices (e.g., autonomous vehicles) that use radar devices. By more effectively validating and/or calibrating radar devices, the disclosed technology can provide various benefits including reduced wear and tear on a vehicle, greater fuel efficiency, improved safety, and/or an overall improvement in the utilization of computational resources that results from improved calibration of radar devices.

By using optimization techniques to calibrate radar devices, the disclosed technology can achieve highly accurate radar detections of an environment. Further, the optimization techniques used by the disclosed technology are computationally inexpensive, allowing for more rapid calibration of radar devices that can be more conveniently and frequently performed.

The disclosed technology can also improve the operation of the vehicle by reducing the amount of wear and tear on vehicle components through more gradual adjustments in the vehicle's travel path that can be performed based on improved radar detections from well calibrated radar devices. For example, more accurate radar detections of the surrounding environment can result in better performance by perception systems of an autonomous vehicle which can in turn result in a safer and smoother ride that has fewer sudden stops and course corrections that impose excessive strain on a vehicle's engine, braking, and steering systems. Additionally, the smoother adjustments by the vehicle (e.g., more gradual turns and acceleration) can have the added benefit of improved passenger comfort when the vehicle is in transit.

The disclosed technology can further improve the operation of the vehicle by improving the fuel efficiency of a vehicle. For example, better calibrated radar devices can result in a more accurate input to a perception system of an autonomous vehicle that better represents the actual state of the surrounding environment. This can result in a more efficient travel path for the autonomous vehicle and/or a travel path that requires less vehicle steering and/or acceleration, thereby achieving a reduction in the amount of energy (e.g., fuel or battery power) that is used to operate the vehicle.

Further, more effective validation and/or calibration of radar devices can allow for an improvement in safety for the operators of devices that use the radar devices (e.g., autonomous vehicles that use radar to determine the state of the surrounding environment for use in navigation) and for individuals that may be impacted by the operation of radar devices (e.g., pedestrians, cyclists, and passengers of other vehicles on the road with an autonomous vehicle that uses a radar device to navigate). For example, the disclosed technology can more effectively avoid unintentional contact with other objects through improved detection of objects by well calibrated radar devices.

By improving the accuracy of radar devices through improved validation and/or calibration, the disclosed technology can reduce the computational resources needed by systems that use radar detections. For example, a properly calibrated radar device can generate radar detections that are more representative of the actual state of the detected environment, which can result in less processing (e.g., manipulation of the radar detections to reduce noise and produce a useable output) by a computing system that uses the radar detections. By way of further example, the improved radar detections generated by well calibrated radar devices can reduce the burden on the perception system and other autonomous vehicle systems that rely on radar detections.

In particular, better radar detections can result in less usage of computational resources including memory resources, processor resources, and bandwidth used to transmit the data associated with the radar detections between systems. As such, the disclosed technology can achieve a reduction in the number of operations that are needed to process radar detections and which can improve the operation of associated systems including autonomous vehicles.

Accordingly, the disclosed technology provides a host of improvements to the validation and/or calibration of radar devices and the overall operation of associated devices (e.g., autonomous vehicles) in general. In particular, the improvements offered by the disclosed technology result in tangible benefits to a variety of systems including the mechanical, electronic, and/or computing systems of autonomous devices.

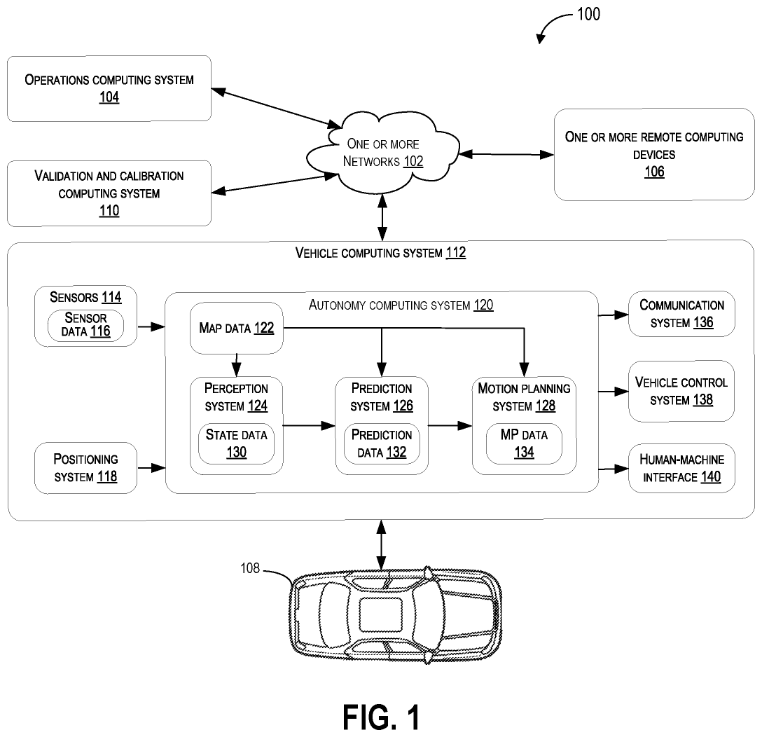

With reference now to FIGS. 1-12, example embodiments of the present disclosure will be discussed in further detail. FIG. 1 depicts a diagram of an example system 100 according to example embodiments of the present disclosure. As illustrated, FIG. 1 shows a system 100 that includes a communications network 102; an operations computing system 104; one or more remote computing devices 106; a vehicle 108; a vehicle computing system 112; one or more sensors 114; sensor data 116; a positioning system 118; an autonomy computing system 120; map data 122; a perception system 124; a prediction system 126; a motion planning system 128; object state data 130; prediction data 132; motion plan data 134; a communication system 136; a vehicle control system 138; and a human-machine interface 140.

The operations computing system 104 can be associated with a service provider that can provide one or more services to a plurality of users via a fleet of vehicles that can include, for example, the vehicle 108. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 108. The one or more computing devices of the operations computing system 104 can include one or more processors and one or more memory devices. The one or more memory devices of the operations computing system 104 can store instructions that when executed by the one or more processors cause the one or more processors to perform one or more operations and/or functions including any of the operations and/or functions of the one or more remote computing devices 106 and/or the vehicle computing system 112. Furthermore, the operations computing system 104 can perform one or more operations and/or functions including operations associated with determining, based at least in part on one or more imaging devices, a plurality of target positions for a plurality of targets; generating, based at least in part on one or more radar devices, a plurality of radar detections of the plurality of targets; generating a plurality of filtered radar detections based at least in part on performance of one or more filtering operations on the plurality of radar detections; determining a detection error for the one or more radar devices based at least in part on one or more calibration operations performed using the plurality of filtered radar detections and the plurality of target positions determined based on the one or more imaging devices; and calibrating the one or more radar devices based at least in part on the detection error.

Furthermore, the one or more memory devices of the operations computing system 104 can store data including instructions used to implement one or more machine-learned models that have been configured and/or trained to generate an output based at least in part on an input provided to the one or more machine-learned models. For example, the one or more machine-learned models stored in the one or more memory devices of the operations computing system 104 can include one or more convolutional neural networks, one or more residual convolutional neural networks, one or more recurrent neural networks, and/or one or more recursive neural networks. Further, the one or more machine-learned models stored in the one or more memory devices of the operations computing system 104 can include one or more machine-learned models, that are described herein.

Furthermore, the operations computing system 104 can be configured to monitor and communicate with the vehicle 108 and/or its users to coordinate a vehicle service provided by the vehicle 108. To do so, the operations computing system 104 can manage a database that includes data including state data associated with the state of one or more objects including one or more objects external to the vehicle 108. The state data can include a location of an object (e.g., a position of an object relative to the vehicle 108 or other point of reference; a latitude of the object, a longitude of the object, and/or an altitude of an object detected by the one or more sensors 114 of the vehicle 108), the state of a vehicle (e.g., the velocity, acceleration, heading, bearing, position, and/or location of the vehicle 108), and/or the state of objects external to a vehicle (e.g., the physical dimensions, speed, velocity, acceleration, heading, shape, sound, and/or appearance of objects external to the vehicle). In some embodiments, the state data can include one or more portions of the sensor data that is described herein.

The operations computing system 104 can communicate with the one or more remote computing devices 106 and/or the vehicle 108 via one or more communications networks including the communications network 102. The communications network 102 can send and/or receive signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 102 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 108.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 108 including sending and/or receiving data or signals to and from the vehicle 108, monitoring the state of the vehicle 108, and/or controlling the vehicle 108. Furthermore, the one or more memory devices of the one or more remote computing devices 106 can be used to store data including the sensor data, data associated with detection error, data associated with output from one or more imaging devices, data associated with output from one or more radar devices, the training data, and/or the one or more machine-learned models that are stored in the operations computing system 104.

The one or more remote computing devices 106 can communicate (e.g., send and/or receive data and/or signals) with one or more devices including the operations computing system 104 and the vehicle 108 via the communications network 102. For example, the one or more remote computing devices 106 can request the location of the vehicle 108 or the state of one or more objects detected by the one or more sensors 114 of the vehicle 108, via the communications network 102.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 108 including a location (e.g., a latitude, longitude, and/or altitude), a speed, a velocity, an acceleration, a trajectory, and/or a path of the vehicle 108 based in part on signals or data exchanged with the vehicle 108. In some implementations, the operations computing system 104 can include some of the one or more remote computing devices 106.

The vehicle 108 can be a ground-based vehicle (e.g., an automobile, a motorcycle, a train, a tram, a truck, a tracked vehicle, a light electric vehicle, a moped, a scooter, and/or an electric bicycle), an aircraft (e.g., a fixed-wing airplane, a helicopter, a vertical take-off and landing (VTOL) aircraft, a short take-off and landing (STOL) aircraft, and/or a tiltrotor aircraft), a boat, a submersible vehicle (e.g., a submarine), an amphibious vehicle, a hovercraft, a robotic device (e.g. a bipedal, wheeled, or quadrupedal robotic device), and/or any other type of vehicle. Further, the vehicle 108 can include a vehicle that can be towed, pushed, and/or carried by another vehicle.

The vehicle 108 can be an autonomous vehicle that can perform various actions including driving, navigating, and/or operating, with minimal and/or no interaction from a human driver. The vehicle 108 can be configured to operate in one or more modes including, for example, a fully autonomous operational mode, a semi-autonomous operational mode, a manually operated mode (e.g., driven by a human driver), a park mode, and/or a sleep mode. A fully autonomous (e.g., self-driving) operational mode can be one in which the vehicle 108 can provide driving and navigational operation with minimal and/or no interaction from a human driver present in the vehicle. A semi-autonomous operational mode can be one in which the vehicle 108 can operate with some interaction from a human driver present in the vehicle. Park and/or sleep modes can be used between operational modes while the vehicle 108 performs various actions including waiting to provide a subsequent vehicle service, and/or recharging between operational modes.

An indication, record, and/or other data indicative of the state of the vehicle 108, the state of one or more passengers of the vehicle 108, and/or the state of an environment external to the vehicle 108 including one or more objects (e.g., the physical dimensions, speed, velocity, acceleration, heading, location, sound, color, and/or appearance of the environment which can include one or more objects) can be stored locally in one or more memory devices of the vehicle 108. Furthermore, the vehicle 108 can provide data indicative of the state of the one or more objects (e.g., physical dimensions, speed, velocity, acceleration, heading, location, sound, color, and/or appearance of the one or more objects) within a predefined distance of the vehicle 108 to the operations computing system 104, which can store an indication, record, and/or other data indicative of the state of the one or more objects within a predefined distance of the vehicle 108 in one or more memory devices associated with the operations computing system 104 (e.g., remote from the vehicle).

The vehicle 108 can include and/or be associated with the validation and calibration computing system 110 and/or the vehicle computing system 112.

The validation and calibration computing system 110 can be associated with one or more devices and/or systems that are used to validate and/or calibrate various devices including one or more imaging devices (e.g., one or more cameras and/or one or more LiDAR devices) and/or one or more radar devices. Further, the validation and calibration computing system 110 can be configured to process data and/or information associated with the detection and/or determination of the position of one or more objects including the plurality of targets described herein (e.g., targets that include a fiducial image detectable by one or more imaging devices and/or a radar reflector that is detectable by one or more radar devices).

The validation and calibration computing system 110 can include multiple components for performing various operations and functions. For example, the validation and calibration computing system 110 can include and/or otherwise be associated with the one or more computing devices that are remote from the vehicle 108. The one or more computing devices of the validation and calibration computing system 110 can include one or more processors and one or more memory devices. The one or more memory devices of the validation and calibration computing system 110 can store instructions that when executed by the one or more processors cause the one or more processors to perform one or more operations and/or functions including any of the operations and/or functions of the one or more remote computing devices 106 and/or the vehicle computing system 112. Furthermore, the validation and calibration computing system 110 can perform one or more operations and/or functions including operations associated with determining, based at least in part on one or more imaging devices, a plurality of target positions for a plurality of targets; generating, based at least in part on one or more radar devices, a plurality of radar detections of the plurality of targets; generating a plurality of filtered radar detections based at least in part on performance of one or more filtering operations on the plurality of radar detections; determining a detection error for the one or more radar devices based at least in part on one or more calibration operations performed using the plurality of filtered radar detections and the plurality of target positions determined based on the one or more imaging devices; and calibrating the one or more radar devices based at least in part on the detection error.

Furthermore, the one or more memory devices of the validation and calibration computing system 110 can store data including instructions used to implement one or more machine-learned models that have been configured and/or trained to generate an output based at least in part on an input provided to the one or more machine-learned models. For example, the one or more machine-learned models stored in the one or more memory devices of the validation and calibration computing system 110 can include one or more convolutional neural networks, one or more residual convolutional neural networks, one or more recurrent neural networks, and/or one or more recursive neural networks. Further, the one or more machine-learned models stored in the one or more memory devices of the validation and calibration computing system 110 can include one or more machine-learned models, that are described herein.

Furthermore, the validation and calibration computing system 110 can be configured to monitor and communicate with the vehicle 108 and/or its users to coordinate a validation and calibration service provided by the vehicle 108. To do so, the validation and calibration computing system 110 can manage a database that includes data including state data associated with the state of one or more objects (e.g., the state of targets detected by one or more imaging devices and/or one or more radar devices) including one or more objects external to the vehicle 108. The state data can include a location of an object (e.g., a position of a target relative to one or more imaging devices, one or more radar devices, and/or other point of reference; a latitude of the object, a longitude of the object, and/or an altitude of an object detected by the one or more imaging devices and/or one or more radar devices); the state of one or more imaging devices and/or one or more radar devices (e.g., the position of an imaging device and/or radar device relative to a plurality of targets); the state of a vehicle (e.g., the velocity, acceleration, heading, bearing, position, and/or location of the vehicle 108); and/or the state of objects external to a vehicle (e.g., the physical dimensions, speed, velocity, acceleration, heading, shape, sound, and/or appearance of objects external to the vehicle). In some embodiments, the state data can include one or more portions of the sensor data 110 and/or the object state data 130 that is described herein.

The validation and calibration computing system 110 can communicate with the operations computing system 104; the one or more remote computing devices 106; the vehicle 108; and/or the vehicle computing system 112 via one or more communications networks including the communications network 102.

The vehicle computing system 112 can include one or more computing devices located onboard the vehicle 108. For example, the one or more computing devices of the vehicle computing system 112 can be located on and/or within the vehicle 108. The one or more computing devices of the vehicle computing system 112 can include various components for performing various operations and functions including any of the one or more operations and/or functions performed by the operations computing system 104 and/or the one or more remote computing devices 106.

Further, the one or more computing devices of the vehicle computing system 112 can include one or more processors and one or more tangible non-transitory, computer readable media (e.g., memory devices). The one or more tangible non-transitory, computer readable media can store instructions that when executed by the one or more processors cause the vehicle 108 (e.g., its computing system, one or more processors, and other devices in the vehicle 108) to perform operations and/or functions, including determining, based at least in part on one or more imaging devices, a plurality of target positions for a plurality of targets; generating, based at least in part on one or more radar devices, a plurality of radar detections of the plurality of targets; generating a plurality of filtered radar detections based at least in part on performance of one or more filtering operations on the plurality of radar detections; determining a detection error for the one or more radar devices based at least in part on one or more calibration operations performed using the plurality of filtered radar detections and the plurality of target positions determined based on the one or more imaging devices; and calibrating the one or more radar devices based at least in part on the detection error. Furthermore, the one or more memory devices of the vehicle computing system 112 can be used to store data including the sensor data, the training data, and/or the one or more machine-learned models that are stored in the operations computing system 104.

Furthermore, the vehicle computing system 112 can perform one or more operations associated with the control, exchange of data, and/or operation of various devices and systems including vehicles, robotic devices, augmented reality devices, and/or other computing devices.

As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 108 (e.g., within range or a field of view of one or more of the one or more sensors 114). In some embodiments, the sensor data 116 can include information associated with one more outputs from one or more imaging devices and/or one or more radar devices. The one or more sensors 114 can include one or more microphones (e.g., a microphone array including a plurality of microphones), one or more Light Detection and Ranging (LiDAR) systems, one or more Radio Detection and Ranging (RADAR) systems, one or more cameras (e.g., visible spectrum cameras and/or infrared cameras), one or more sonar systems, one or more motion sensors, and/or other types of image capture devices and/or sensors.

The sensor data 116 can include image data (e.g., image data generated by one or more imaging devices including at least one camera), radar data (e.g., radar data including a plurality of radar detections generated by one or more radar devices), LiDAR data (e.g., LiDAR data including one or more LiDAR detections generated by one or more imaging devices including at least one LiDAR device), sound data, sonar data, and/or other data acquired by the one or more sensors 114. The one or more objects detected by the one or more sensors 114 can include, for example, pedestrians, cyclists, vehicles, bicycles, buildings, roads, sidewalks, trees, foliage, utility structures, bodies of water, and/or other objects. The one or more objects can be located on or around (e.g., in the area surrounding the vehicle 108) various parts of the vehicle 108 including a front side, rear side, port side (e.g., the left side of the vehicle from the perspective of a passenger inside the vehicle that is facing the front side of the vehicle), starboard side (e.g., the right side of the vehicle from the perspective of a passenger inside the vehicle that is facing the front side of the vehicle), top, or bottom of the vehicle 108.

The sensor data 116 can be indicative of locations associated with the one or more objects within the surrounding environment of the vehicle 108 at one or more times. For example, the sensor data 116 can be indicative of one or more motion features and/or appearance features associated with one or more objects in an environment detected by the one or more sensors 114 including a LiDAR device and/or camera. By way of further example, the sensor data 116 can be indicative of a LiDAR point cloud data and/or images (e.g., raster images) associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 108. For example, the map data 122 can provide information regarding: the identity and/or location of different roadways, road segments, buildings, or other items or objects (e.g., lampposts, crosswalks and/or curbs); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and determining the state of its surrounding environment and its relationship thereto.

The vehicle computing system 112 can include a positioning system 118. The positioning system 118 can determine a current position of the vehicle 108. The positioning system 118 can be any device or circuitry for analyzing the position of the vehicle 108. For example, the positioning system 118 can determine a position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 108 can be used by various systems of the vehicle computing system 112 and/or provided to one or more remote computing devices (e.g., the operations computing system 104 and/or the remote computing device 106). For example, the map data 122 can provide the vehicle 108 relative positions of the surrounding environment of the vehicle 108. The vehicle 108 can identify its position within the surrounding environment (e.g., across six axes) based at least in part on the data described herein. For example, the vehicle 108 can process the sensor data 116 (e.g., LiDAR data, camera data) to match it to a map of the surrounding environment to get a determination of the vehicle's position within that environment (e.g., transpose the vehicle's position within its surrounding environment).

The autonomy computing system 120 can include a perception system 124, a prediction system 126, a motion planning system 128, and/or other systems that cooperate to determine the state of the surrounding environment of the vehicle 108 and determine a motion plan for controlling the motion of the vehicle 108 accordingly. For example, the autonomy computing system 120 can receive the sensor data 116 from the one or more sensors 114, attempt to determine the state of the surrounding environment by performing various processing techniques on the sensor data 116 (and/or other data), and generate an appropriate motion plan through the surrounding environment, including for example, a motion plan navigates the vehicle 108 around the current and/or predicted locations of one or more objects detected by the one or more sensors 114. The autonomy computing system 120 can control the one or more vehicle control systems 138 to operate the vehicle 108 according to the motion plan. One or more of the perception system 124, the prediction system 126, and/or the motion planning system 128 can be included in the same system and/or share at least some computational resources (e.g., processors, memory, and/or storage.).

The autonomy computing system 120 can identify one or more objects that are proximate to the vehicle 108 based at least in part on the sensor data 116 and/or the map data 122. For example, the perception system 124 can obtain object state data 130 descriptive of a current and/or past state of an object that is proximate to the vehicle 108. The object state data 130 for each object can describe, for example, an estimate of the object's current and/or past: location and/or position; speed; velocity; acceleration; heading; orientation; size/footprint (e.g., as represented by a bounding shape); class (e.g., pedestrian class, vehicle class, or bicycle class), and/or other state information. The perception system 124 can provide the object state data 130 to the prediction system 126 (e.g., for predicting the movement of an object).

The prediction system 126 can generate prediction data 132 associated with each of the respective one or more objects proximate to the vehicle 108. The prediction data 132 can be indicative of one or more predicted future locations of each respective object. The prediction data 132 can be indicative of a predicted path (e.g., predicted trajectory) of at least one object within the surrounding environment of the vehicle 108. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 108 based at least in part on the prediction data 132 (and/or other data). The motion plan data 134 can include vehicle actions with respect to the objects proximate to the vehicle 108 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 108 can perform a certain action (e.g., pass an object) without increasing the potential risk to the vehicle 108 and/or violating any traffic laws (e.g., speed limits, lane boundaries, signage). The motion plan data 134 can include a planned trajectory, velocity, acceleration, and/or other actions of the vehicle 108.

The motion planning system 128 can provide the motion plan data 134 with data indicative of the vehicle actions, a planned trajectory, and/or other operating parameters to the vehicle control systems 138 to implement the motion plan data 134 for the vehicle 108. For instance, the vehicle 108 can include a mobility controller configured to translate the motion plan data 134 into instructions. By way of example, the mobility controller can translate a determined motion plan data 134 into instructions for controlling the vehicle 108 including adjusting the steering of the vehicle 108 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections). In some implementations, the communications system 136 can allow communication among one or more of the system on-board the vehicle 108. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop and/or smartphone) can be viewable by a user of the vehicle 108 that is located in the front of the vehicle 108 (e.g., driver's seat or front passenger seat). Additionally, or alternatively, a display device can be viewable by a user of the vehicle 108 that is located in the rear of the vehicle 108 (e.g., a back passenger seat). For example, the autonomy computing system 120 can provide one or more outputs including a graphical display of the location of the vehicle 108 relative to one or more objects detected by the one or more sensors 114 including one or more radar devices. By way of further example, the autonomy computing system 120 can provide one or more outputs including a graphical display of the location of the vehicle 108 on a map of a geographical area within one kilometer of the vehicle 108, including the locations of objects around the vehicle 108. A passenger of the vehicle 108 can interact with the one or more human-machine interfaces 140 by touching a touchscreen display device associated with the one or more human-machine interfaces to indicate, for example, a stopping location for the vehicle 108.

In some embodiments, the vehicle computing system 112 can perform one or more operations including activating, based at least in part on one or more signals or data (e.g., the sensor data 116, the map data 122, the object state data 130, the prediction data 132, and/or the motion plan data 134) one or more vehicle systems associated with operation of the vehicle 108. For example, the vehicle computing system 112 can send one or more control signals to activate one or more vehicle systems that can be used to control and/or direct the travel path of the vehicle 108 through an environment.

By way of further example, the vehicle computing system 112 can activate one or more vehicle systems including: the communications system 136 that can send and/or receive signals and/or data with other vehicle systems, other vehicles, or remote computing devices (e.g., remote server devices); one or more lighting systems (e.g., one or more headlights, hazard lights, and/or vehicle compartment lights); one or more vehicle safety systems (e.g., one or more seatbelt and/or airbag systems); one or more notification systems that can generate one or more notifications for passengers of the vehicle 108 (e.g., auditory and/or visual messages about the state or predicted state of objects external to the vehicle 108); braking systems; propulsion systems that can be used to change the acceleration and/or velocity of the vehicle which can include one or more vehicle motor or engine systems (e.g., an engine and/or motor used by the vehicle 108 for locomotion); and/or steering systems that can change the path, course, and/or direction of travel of the vehicle 108.

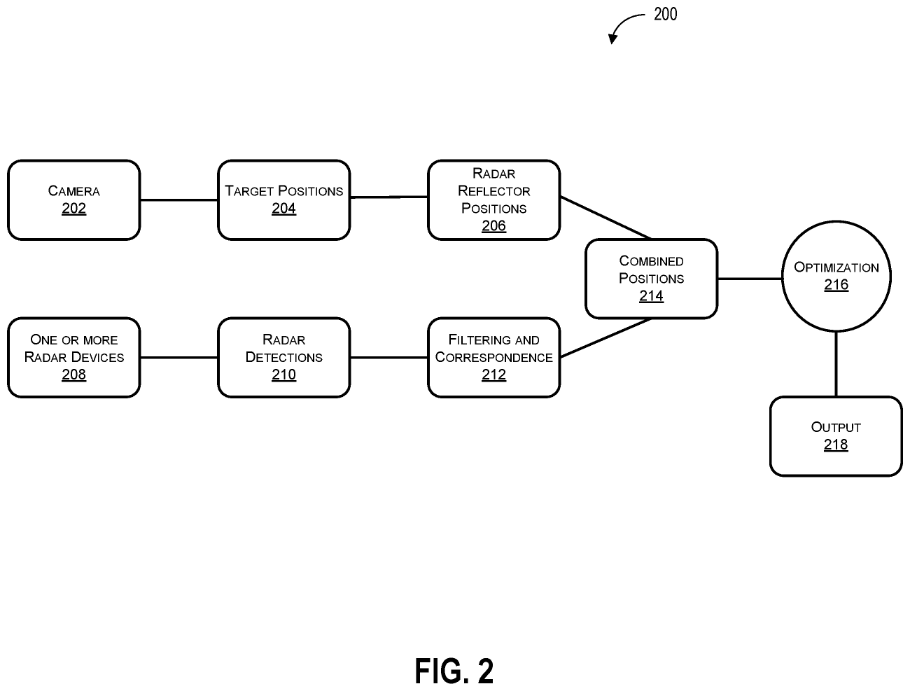

FIG. 2 depicts an example of a technique for radar error measurement according to example embodiments of the present disclosure. One or more operations and/or functions in FIG. 2 can be implemented and/or performed by one or more devices (e.g., one or more computing devices) and/or systems including, for example, the operations computing system 104, the vehicle 108, the validation and calibration computing system 110, or the vehicle computing system 112, which are depicted in FIG. 1. Further, the one or more devices and/or systems in FIG. 2 can include one or more features of one or more devices and/or systems including, for example, the operations computing system 104, the vehicle 108, or the vehicle computing system 112, which are depicted in FIG. 1.

As illustrated, FIG. 2 shows an example of a radar calibration technique 200 including camera 202, camera target positions 204, radar reflector positions 206, one or more radar devices 208, radar detections 210, radar filtering 212, combined positions 214, optimization 216, and offset output 218.

The radar calibration technique 200 can include one or more operations that are used to generate an output (e.g., a detection error) that can be used to validate and/or calibrate the one or more radar devices 208.

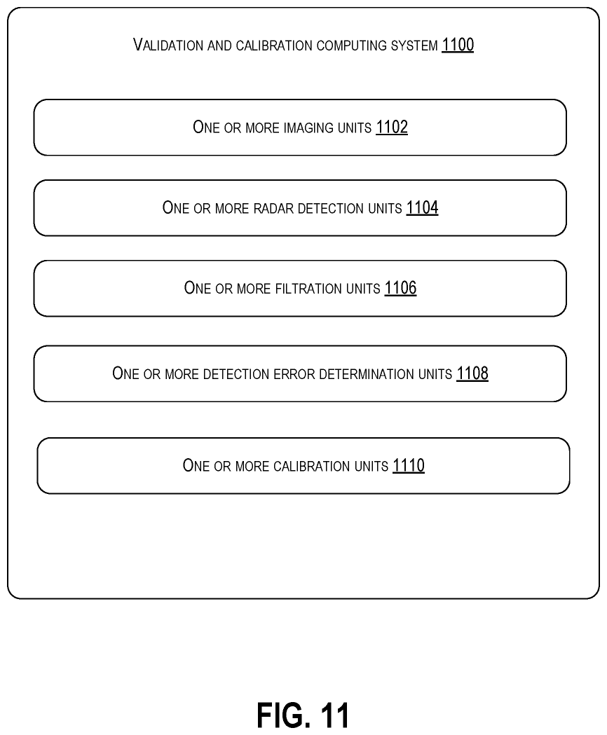

The camera 202 can include an optical camera that is positioned to capture a plurality of images of a plurality of targets that are located at a plurality of different distances from the camera 202. The camera 202 can, for example, include a high-resolution camera that is mounted on a stand that aims the camera at a plurality of targets such that the plurality of targets are in the field of view of the camera 202. The camera 202 can be configured to capture one or more images of each of the plurality of targets individually and/or to capture one or more images of a subset of the plurality of targets (e.g., some or all of the plurality of targets). Further, the camera 202 can be associated with a computing system (e.g., the validation and calibration computing system 110 depicted in FIG. 1; and/or the validation and calibration computing system 1100 depicted in FIG. 11). The camera 202 can generate information and/or data associated with the one or more images of the plurality of targets that are captured including the camera target positions 204.

The camera target positions 204 can include the distance and/or orientation of any of the plurality of targets relative to the camera 202. In some embodiments, the camera target positions 204 can include a distance in meters from the camera 202; an orientation and/or bearing relative to the camera 202; and/or a latitude, a longitude, and/or an altitude of any of the plurality of targets.

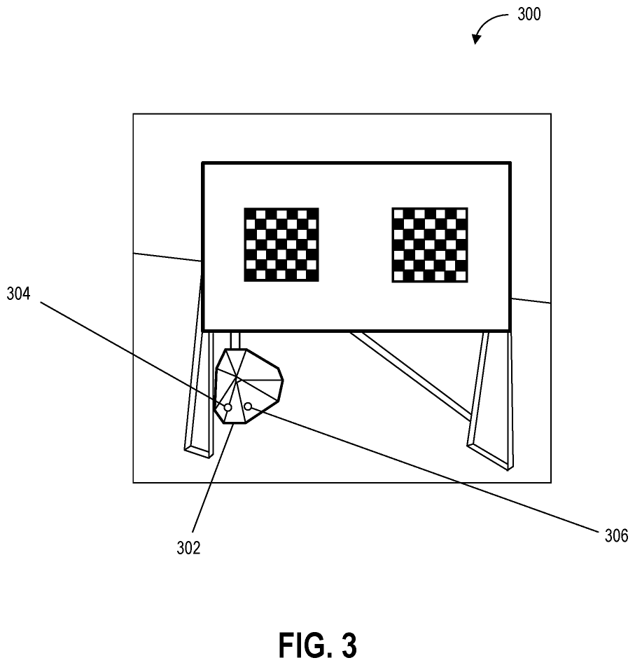

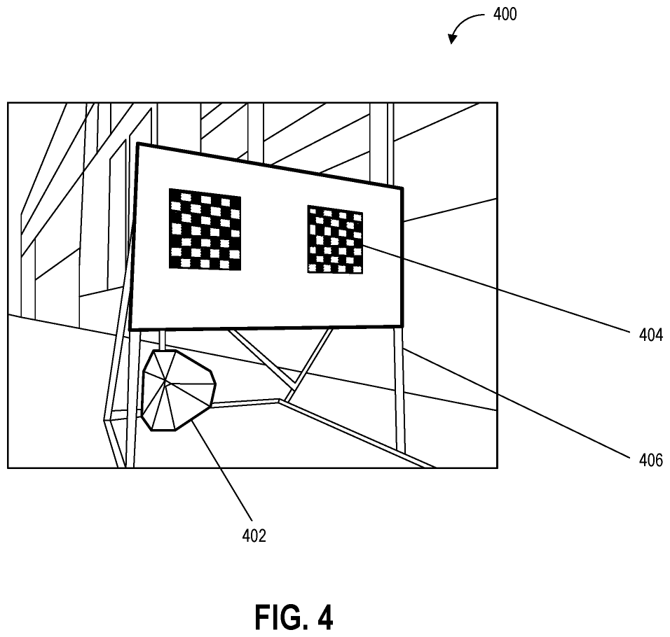

Each of the plurality of targets (e.g., targets that include any of the attributes and/or capabilities of the target 300 that is depicted in FIG. 3 and/or the target 400 that is depicted in FIG. 4) can include a fiducial image that can be used by the camera 202 to determine the position and/or location (e.g., distance and/or orientation) of each respective target relative to the camera 202. Each fiducial image can include various shapes (e.g., square, circular, and/or rectangular) , colors (e.g., black, white, red, blue, and/or green), sizes, patterns (e.g., checks, zig-zags, horizontal and/or vertical lines) that can be used (e.g., as a visual point of reference) to determine the position and/or orientation of the plurality of targets. Detection of the fiducial images on the respective plurality of targets can result in determination of the camera target positions 204 which can include the positions of the respective plurality of targets.

Further, each of the plurality of targets can include a respective radar reflector. The radar reflectors associated with the plurality of targets can be positioned at the radar reflector positions 206. Each of the radar reflector positions 206 can be a predetermined location (e.g., a predetermined orientation and distance) relative to each respective fiducial image. For example, a radar reflector can be positioned thirty (30) centimeters below the lower left corner of a fiducial image. As such, once the position of each fiducial image is determined, the radar reflector positions 206 can be determined based on the determined position of each of the plurality of fiducial targets on the respective plurality of targets.

The radar detections 210 can include one or more outputs generated by one or more radar devices 208 that are used to detect the plurality of radar reflectors located on the same plurality of targets that are captured by the camera 202. Each of the one or more radar devices 208 that generate the radar detections 210 can be positioned at a predetermined position relative to the camera 202. As such, the positions of the plurality of radar reflectors determined based at least in part on the radar detections 210 can then be compared to the positions of the plurality of targets determined by the camera 202.

The radar filtering and correspondence 212 can include one or more operations to filter the radar detections 210 and generate filtered radar detections. The filtered radar detections can include a set of the radar detections 210 that have been filtered to reduce noise (e.g., radar detections that are not associated with the plurality of targets). Further the radar and filtering 212 can include one or more operations to establish a correspondence between a set of the radar detections 210 and the radar devices that generated the set of the radar detections 210, the time at which the set of the radar detections 210 were generated, the particular radar device that generated the set of the radar detections 210, and/or the time at which the set of the radar detections 210 were generated.

The combined positions 214 can include the target positions determined by the camera 202 and the target positions determined based on the radar detections 210. For example, the combined positions 214 can include information and/or data that includes sets of target positions for each target of the plurality of targets. Each of the combined positions 214 can include a distance and/or orientation of each target that was determined by the camera 202 and the one or more radar devices 208.

The optimization 216 can include one or more operations performed on the combined positions 214. The optimization 216 can include using the combined positions 214 as part of an input that can be used to determine the detection error in the one or more radar devices 208 relative to the camera 202. The optimization 216 can include, for example, the minimization of a non-linear least-squares function that includes parameters that correspond to the outputs and positions of the camera 202 and the radar 208.

The offset output 218 can include the output of the optimization 216. Further, the offset output 218 can include data and/or information that can be used to validate and/or calibrate the one or more radar devices 208. For example, the offset output 218 can include a detection error that indicates the difference between the radar reflector positions 206 and the position based on the radar detections 210. The offset output 218 can be used to calibrate the one or more radar devices 208. For example, the offset output 218 can include a yaw offset that can be used to adjust the yaw of the one or more radar devices 208 so that the positions of the plurality of targets determined by the one or more radar devices 208 is closer to the position of the plurality of targets determined by the camera 202.

FIG. 3 depicts an example of comparing radar detections of a target according to example embodiments of the present disclosure. One or more operations and/or functions in FIG. 3 can be implemented and/or performed by one or more devices (e.g., one or more computing devices) and/or systems including, for example, the operations computing system 104, the vehicle 108, the validation and calibration computing system 110, or the vehicle computing system 112, which are depicted in FIG. 1. Further, the one or more devices and/or systems in FIG. 3 can include one or more features of one or more devices and/or systems including, for example, the operations computing system 104, the vehicle 108, or the vehicle computing system 112, which are depicted in FIG. 1.

As illustrated, FIG. 3 shows an example of target 300 including a radar reflector 302, a detection 304, and a detection 306.

The target 300 (e.g., a target that can include any of the attributes and/or capabilities of the target 200 that is depicted in FIG. 2) can be configured to be detected by one or more imaging devices and/or one or more radar devices. In this example, the detection 304 indicates a position on the radar reflector 302 that was determined based on a radar device that detected the target 300. The detection 306 indicates an expected position of the radar reflector 302 that was determined based on an imaging device that determines the position of the radar reflector 302 that a well calibrated radar device would determine.

The difference between the position or location of the detection 304 and the detection 306 can be associated with a detection error that can be used as a basis for validating and/or calibrating a radar device so that subsequent detections of the same radar reflector from the same position of the radar device will be closer to the detection 306. The distance between the detection 304 and the detection 306 can be positively correlated with the detection error such that a greater distance between the detection 304 and the detection 306 can be associated with a greater detection error.

FIG. 4 depicts an example of a target used for radar calibration according to example embodiments of the present disclosure. One or more operations and/or functions in FIG. 4 can be implemented and/or performed by one or more devices (e.g., one or more computing devices) and/or systems including, for example, the operations computing system 104, the vehicle 108, the validation and calibration computing system 110, or the vehicle computing system 112, which are depicted in FIG. 1. Further, the one or more devices and/or systems in FIG. 4 can include one or more features of one or more devices and/or systems including, for example, the operations computing system 104, the vehicle 108, or the vehicle computing system 112, which are depicted in FIG. 1.

As illustrated, FIG. 4 shows an example of a target 400 including a radar reflector 402, a fiducial image 404, and a stand 406.

In this example, the target 400 is on a ground surface and includes the radar reflector 402 and the fiducial image 404 which are attached (connected) to the stand 406. The target 400 can be positioned at a set of distances (e.g., multiple different distances) from a set of sensors including one or more imaging devices and/or one or more radar devices that are configured to detect the target 400. Further, the target 400 can be positioned at different angles and/or orientations relative to the set of sensors including the one or more imaging devices and/or one or more radar devices.

The stand 406 can be configured to hold the radar reflector 402 and the fiducial image 404 in an upright position that is substantially perpendicular (e.g., perpendicular within a range of thirty (30) degrees with respect to the ground surface) to the surface on which the stand 406 is placed. The stand 406 can be configured so that the radar reflector 402 can reflect radio waves generated by a radar device; and the fiducial image 404 is detectable by an imaging device (e.g., a camera or LiDAR device). Further, the stand 406 can be configured so that the radar reflector 402 is in a predetermined position (e.g., a predetermined distance and angle) relative to the fiducial image 404. In some embodiments, the stand 406 can be composed of a material that is less reflective of radar signals (e.g., fiberglass, wood, or plastic) than, for example, a stand that is composed of a material that is more reflective of radar (e.g., a metallic stand). Further, the stand 406 can be configured to be adjusted to different heights and/or orientations relative to the set of sensors and/or the surface on which the stand 406 is placed.

The radar reflector 402 can be in a predetermined position relative to the fiducial image 404 (e.g., fifteen (15) centimeters below the fiducial image 404), which can facilitate comparison of a position of the radar reflector 402 determined based in part on radar detections of the radar reflector 402 by a radar device to a position of the fiducial image 404 based in part on detection of the position of the fiducial image 404 by an imaging device.

The radar reflector 402 can be composed of material that is more reflective of radar signals (e.g., metal) and can be configured in a variety of shapes including a three-piece corner reflector shape or an octahedral reflector shape. The radar reflector 402 can be configured to improve the signal intensity of radar signals that are transmitted in the direction of the radar reflector 402.

The fiducial image 404 can include one or more images that can be detected by an imaging device (e.g., a camera). Further, the fiducial image 404 can indicate the three-dimensional location, distance, orientation, and/or identity of the fiducial image 404 relative to an imaging device that detects the fiducial image 404. For example, the target 400 that includes the fiducial image 404 can be one of a plurality of fiducial images on a respective plurality of targets that are arranged at a respective plurality of distances and/or orientations relative to an imaging device and/or a radar device that are configured to detect the plurality of targets.

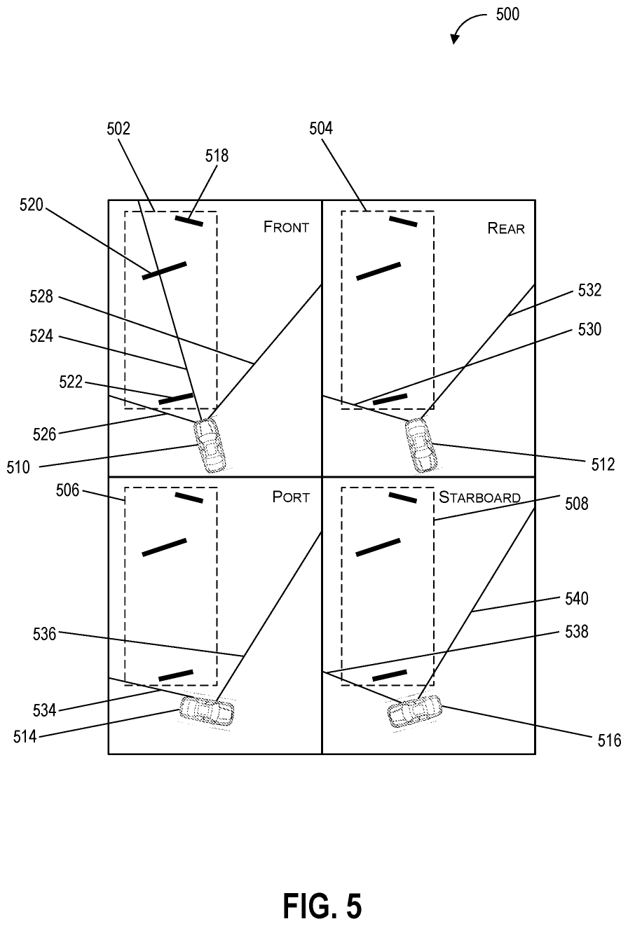

FIG. 5 depicts an example of a validation and calibration technique according to example embodiments of the present disclosure. The orientations, numbers, angles, configurations, and/or relative sizes of the vehicles, devices, and/or signals are shown by way of example only. The orientations, numbers, angles, configurations, and/or relative sizes of the vehicles, devices, and/or signals shown can vary. One or more operations and/or functions in FIG. 5 can be implemented and/or performed by one or more devices (e.g., one or more computing devices) and/or systems including, for example, the operations computing system 104, the vehicle 108, the validation and calibration computing system 110, or the vehicle computing system 112, which are depicted in FIG. 1. Further, the one or more devices and/or systems in FIG. 5 can include one or more features of one or more devices and/or systems including, for example, the operations computing system 104, the vehicle 108, or the vehicle computing system 112, which are depicted in FIG. 1.

As illustrated, FIG. 5 shows an example of validation and calibration technique 500 including front detections 502, rear detections 504, port detections 506, a starboard detections 508, a vehicle at position 510, the vehicle at position 512, the vehicle at position 514, the vehicle at position 516, a target 518, a target 520, a target 522, a radar signal 524, a radar signal 526, a radar signal 528, a radar signal 530, a radar signal 532, a radar signal 534, a radar signal 536, a radar signal 538, and a radar signal 540.

In this example, the validation and calibration technique 500 includes a vehicle on which one or more radar devices and/or one or more imaging devices (e.g., one or more cameras and/or one or more LiDAR devices) are mounted (e.g., located and/or positioned on). The one or more radar devices and/or the one or more imaging devices can be mounted on the front, rear, port, and starboard portions of the vehicle so that the one or more detections by the one or more radar devices and/or the one or more imaging devices generate the front detections 502, the rear detections 504, the port detections 506, and the starboard detections 508 respectively. The front detections 502, rear detections 504, port detections 506, and starboard detections 508 can include a plurality of radar detections, a plurality of images, and/or a plurality of LiDAR returns.

Further, the front detections 502, rear detections 504, port detections 506, and starboard detections 508 can be used to determine the positions of the targets 518/520/522.

Each of the targets 518/520/522 can include a fiducial image and/or a radar reflector and can include any of the attributes and/or capabilities of the target 300 that is depicted in FIG. 3 and/or the target 400 that is depicted in FIG. 4. In this example, each of the targets 518/520/522 can be located in a fixed position though in other embodiments, any of the targets 518/520/522 can be moved to different positions including different distances and/or orientations relative to the vehicle position 510.

The vehicle can be turned to the vehicle positions 510/512/514/516 so that a different set of the one or more radar devices is aimed at the targets 518/520/522 and generates the front detections 502 (at the vehicle position 510), the rear detections 504 (at the vehicle position 512), the port detections 506 (at the vehicle position 514), and the starboard detections 508 (at the vehicle position 516) respectively. Turning the vehicle can be achieved through turning the vehicle itself (e.g., an autonomous vehicle turning itself or a manually operated vehicle being turned by a human driver) or through use of a device (e.g., a turntable or other turning device on which the vehicle is placed) that turns the vehicle and positions the vehicle at positions 510/512/514/516.

As shown in FIG. 5, radar devices (e.g., eight (8) radar devices, with two radar devices on the front side of the vehicle, rear side of the vehicle, port side of the vehicle, and starboard side of the vehicle respectively) located on a vehicle can generate the radar signals 524-540. The radar signals 524-540 can have a field of view (e.g., a region and/or area of the environment that is detected or detectable using radar signals of a radar device) of approximately (e.g., plus or minus twenty-five (25) degrees) sixty (60) degrees from a centerline associated with a radar signal in the center or middle (e.g., equidistant from radar signals at the outer edges of the field of view) of a plurality of radar signals. For example, the radar device on the front side of the vehicle can have a field of view of approximately one-hundred and twenty (120) degrees. Further, the radar signal 526 (which is to the left of the radar signal 524) can be approximately sixty (60) degrees from the radar signal 524 (e.g., the radar signal associated with a centerline of the radar device that generates the radar signals 524-528); and the radar signal 528 (which is to the right of the radar signal 524) can be approximately sixty (60) degrees from the radar signal 524. In some embodiments, different radar devices with different fields of view can be used. For example, the radar devices on the front side of the vehicle can have a field of view that is wider than the field of view of the radar devices on the port side of the vehicle.

Furthermore, the front detections 502 include detection of the targets 518/520/522 which are within the field of view that includes the radar signal 526 and the radar signal 528 (e.g., the field of view with the radar signal 526 at one edge of the field of view, the radar signal 528 at the opposite edge of the field of view, and a plurality of radar signals including the radar signal 524 between the radar signal 526 and the radar signal 528); the rear detections 504 include detection of the targets 518/520/522 which are within the field of view that includes the radar signal 530 and the radar signal 532 (e.g., the field of view with the radar signal 530 at one edge of the field of view, the radar signal 532 at the opposite edge of the field of view, and a plurality of radar signals between the radar signal 530 and the radar signal 532); the port detections 506 include detection of the targets 518/520/522 which are within the field of view that includes the radar signal 534 and the radar signal 536 (e.g., the field of view with the radar signal 534 at one edge of the field of view, the radar signal 536 at the opposite edge of the field of view, and a plurality of radar signals between the radar signal 534 and the radar signal 536); and the starboard detections 508 include detection of the targets 518/520/522 which are within the field of view that includes the radar signal 538 and the radar signal 540 (e.g., the field of view with the radar signal 538 at one edge of the field of view, the radar signal 540 at the opposite edge of the field of view, and a plurality of radar signals between the radar signal 538 and the radar signal 540).

Anomalous, inaccurate, and/or incorrect detections of the targets 518/520/522 can be determined and associated with a detection error for the respective one or more radar devices on the vehicle. The detection error can be corrected, reduced, and/or ameliorated through calibration of the one or more radar devices (e.g., adjusting the configuration, location, orientation, and/or position of the one or more radar devices). For example, the orientation (e.g., yaw, pitch, and/or roll) of the one or more radar devices can be adjusted. Further, the location of any of the one or more radar devices with respect to the vehicle can be adjusted (e.g., the height of a radar device or a location of a radar device on the vehicle can be changed).

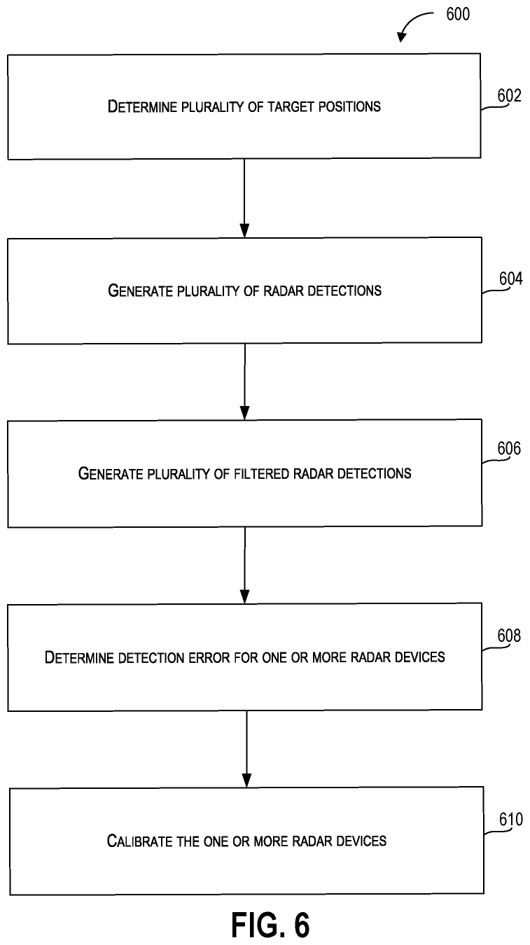

FIG. 6 depicts a flow diagram of an example of radar validation and calibration according to example embodiments of the present disclosure. One or more portions of a method 600 can be implemented by one or more devices (e.g., one or more computing devices) or systems including, for example, the operations computing system 104, the vehicle 108, the validation and calibration computing system 110, or the vehicle computing system 112, shown in FIG. 1. Moreover, one or more portions of the method 600 can be implemented as an algorithm on the hardware components of the devices described herein (e.g., as in FIG. 1). FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 602, the method 600 can include determining a plurality of target positions for a plurality of targets. Determining the plurality of target positions can be based at least in part on one or more imaging devices. The plurality of targets can be located at a respective plurality of predetermined positions relative to the one or more imaging devices. For example, the vehicle computing system 112 can be configured to control the one or more imaging devices by sending one or more control signals that cause the one or more imaging devices to capture one or more images of the plurality of targets that can be used to determine the position (e.g., location, distance, and/or orientation) of each of the plurality of targets. Further, the determination of the plurality of target positions can be based at least in part on determination of the position of a respective plurality of fiducial images and respective plurality of radar reflectors located on each of the plurality of targets. Determination of the plurality of target positions can include generation of information and/or data that can be used by a computing system to perform one or more operations including one or more calibration operations and/or one or more optimization operations.

In some embodiments, the plurality of imaging devices can include a first imaging device and/or a second imaging device. Further, any of the plurality of imaging devices including the first imaging device and the second imaging device can be cross-validated against each other.

At 604, the method 600 can include generating a plurality of radar detections of the plurality of targets. Generating the plurality of radar detections can be based at least in part on one or more radar devices. The one or more radar devices can be located at a predetermined position relative to the one or more imaging devices. For example, the vehicle computing system 112 can be configured to control the one or more radar devices by sending one or more control signals that cause the one or more radar devices to generate one or more radar signals that are directed towards the plurality of targets and can be used to determine the position (e.g., location, distance, and/or orientation) of each of the plurality of targets. Further, the determination of the plurality of target positions can be based at least in part on determination of the position of a respective radar reflector located on each of the plurality of targets. Generation of the plurality of radar detections can include generation of information and/or data that can be used by a computing system to perform one or more operations including one or more calibration operations, one or more noise filtering operations, and/or one or more optimization operations.

At 606, the method 600 can include generating a plurality of filtered radar detections. the plurality of filtered radar detections can be based at least in part on performance of one or more filtering operations on the plurality of radar detections. For example, the vehicle computing system 112 can perform one or more operations (e.g., one or more noise filtering operations using the information and/or data associated with the plurality of radar detections) to filter noise (e.g., radar detections that are not associated with the position of the plurality of radar reflectors located on each of the plurality of targets) from the plurality of radar detections. Filtering the plurality of radar detections can result in an improvement in the accuracy of the plurality of radar detections.

At 608, the method 600 can include determining a detection error for the one or more radar devices. In some embodiments, one or more detection errors can be determined for each of the one or more radar devices respectively. The detection error can be based at least in part on one or more calibration operations performed using the plurality of target positions determined based on the one or more imaging devices and/or the plurality of filtered radar detections. Further, the one or more calibration operations can be based at least in part on the information and/or data associated with the plurality of target positions and/or the plurality of radar detections.

For example, the vehicle computing system 112 can perform one or more calibration operations based at least in part on optimization using a function that includes one or more parameters associated with the plurality of target positions and target positions based at least in part on the plurality of filtered radar detections. The result of the optimization can include a detection error for the one or more radar devices. The detection error for the one or more radar devices can, for example, be associated with the configuration of any of the one or more radar devices including a yaw offset of each of the one or more radar devices respectively.

At 610, the method 600 can include calibrating the one or more radar devices based at least in part on the detection error. For example, the vehicle computing system 112 can generate one or more control signals that can be used to calibrate the one or more radar devices by adjusting (e.g., using a mechanism that is configured to move and/or adjust each of the one or more radar devices) one or more configurations of the one or more radar devices. The adjustment to the one or more configurations of the one or more radar devices can include adjustment of any position of the one or more radar devices including adjusting a respective yaw, pitch, roll, and/or location of any of the one or more radar devices with respect to some point of reference (e.g., a vehicle on which the one or more radar devices are mounted).

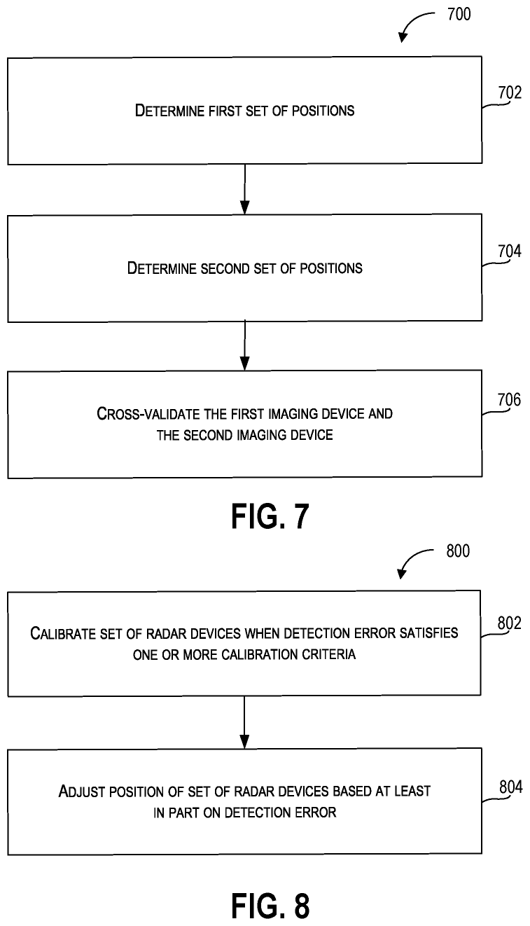

FIG. 7 depicts a flow diagram of an example of radar validation and calibration according to example embodiments of the present disclosure. One or more portions of a method 700 can be implemented by one or more devices (e.g., one or more computing devices) or systems including, for example, the operations computing system 104, the vehicle 108, the validation and calibration computing system 110, or the vehicle computing system 112, shown in FIG. 1. Moreover, one or more portions of the method 700 can be implemented as an algorithm on the hardware components of the devices described herein (e.g., as in FIG. 1). In some embodiments, one or more portions of the method 700 can be performed as part of the method 600 that is depicted in FIG. 6. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 702, the method 700 can include determining a first set of positions of the plurality of targets. Determining the first set of positions of the plurality of targets can be based at least in part on the first imaging device (e.g., the first imaging device described in 602 of the method 600 that is depicted in FIG. 6). For example, the vehicle computing system 112 can generate one or more control signals that are used to activate and/or control the first imaging device and cause the first imaging device to capture one or more images of the plurality of targets. The one or more images of the plurality of targets can then be used to determine the first set of positions of the plurality of targets.

At 704, the method 700 can include determining a second set of positions of the plurality of targets. Determining the second set of positions of the plurality of targets can be based at least in part on the second imaging device (e.g., the second imaging device described in 602 of the method 600 that is depicted in FIG. 6). For example, the vehicle computing system 112 can generate one or more control signals that are used to activate and/or control the second imaging device and cause the second imaging device to capture one or more images of the plurality of targets. The one or more images of the plurality of targets can then be used to determine the second set of positions of the plurality of targets.

At 706, the method 700 can include cross-validating the first imaging device and the second imaging device based at least in part on one or more comparisons of the first set of positions to the second set of positions. For example, the vehicle computing system 112 can compare the positions (e.g., distances and/or orientations) of the plurality of targets associated with the first set of positions determined by the first imaging device to the positions (e.g., distances and/or orientations) of the plurality of targets associated with the second set of positions determined by the second imaging device. The difference between the first set of positions and the second set of positions can be used to cross-validate the first imaging device and/or the second imaging device.

FIG. 8 depicts a flow diagram of an example of radar validation and calibration according to example embodiments of the present disclosure. One or more portions of a method 800 can be implemented by one or more devices (e.g., one or more computing devices) or systems including, for example, the operations computing system 104, the vehicle 108, the validation and calibration computing system 110, or the vehicle computing system 112, shown in FIG. 1. Moreover, one or more portions of the method 800 can be implemented as an algorithm on the hardware components of the devices described herein (e.g., as in FIG. 1). In some embodiments, one or more portions of the method 800 can be performed as part of the method 600 that is depicted in FIG. 6. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, the method 800 can include calibrating the one or more radar devices when or if the detection error (e.g., the detection error determined at 608 that is depicted in FIG. 6) satisfies one or more calibration criteria. The one or more calibration criteria can include the detection error exceeding a maximum detection error threshold.

For example, the vehicle computing system 112 can generate one or more control signals to perform one or more operations associated with calibration of the one or more radar devices (e.g., controlling a mechanism that adjusts the one or more radar devices when the detection error exceeds some maximum detection error threshold). When the one or more calibration criteria are not satisfied (e.g., the detection error is within an acceptable range that does not exceed the maximum detection error threshold), the vehicle computing system 112 can continue to receive information and/or data associated with the one or more radar devices (e.g., receive data comprising the detection error).

At 804, the method 800 can include adjusting, moving, and/or changing one or more positions of the one or more radar devices based at least in part on the detection error. For example, the vehicle computing system 112 can generate one or more control signals to control the configuration (e.g., the location, orientation, and/or position) of any of the one or more radar devices (e.g., using one or more mechanisms that are configured to move and/or adjust the one or more radar devices) and thereby adjust the one or more radar devices based at least in part on the detection error. The vehicle computing system 112 can, based on the detection error, adjust the location, yaw, roll, and/or pitch of each of the one or more radar devices respectively.

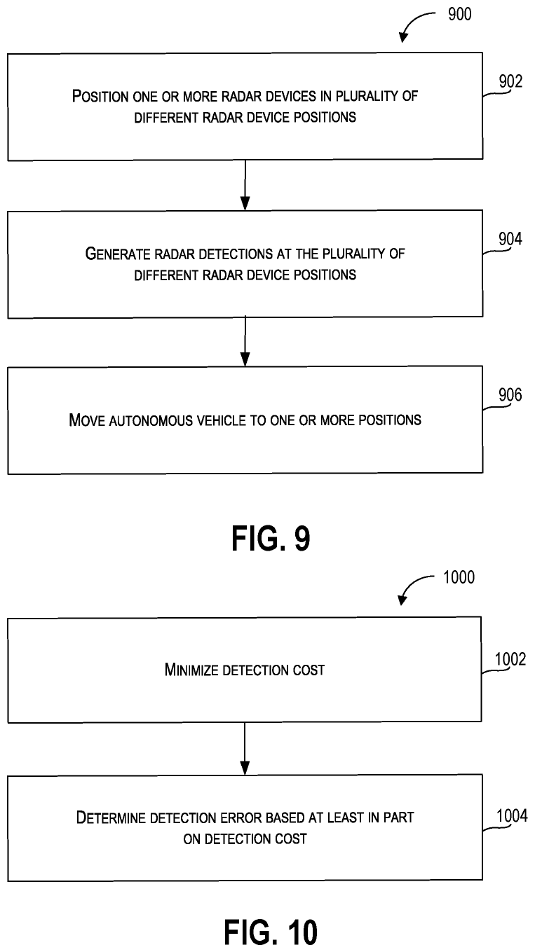

FIG. 9 depicts a flow diagram of an example of radar validation and calibration according to example embodiments of the present disclosure. One or more portions of a method 900 can be implemented by one or more devices (e.g., one or more computing devices) or systems including, for example, the operations computing system 104, the vehicle 108, the validation and calibration computing system 110, or the vehicle computing system 112, shown in FIG. 1. Moreover, one or more portions of the method 900 can be implemented as an algorithm on the hardware components of the devices described herein (e.g., as in FIG. 1). In some embodiments, one or more portions of the method 900 can be performed as part of the method 600 that is depicted in FIG. 6. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include positioning the one or more radar devices in a plurality of different radar device positions relative to the plurality of targets. For example, the one or more radar devices can be positioned at different radar device positions including different distances relative to the plurality of targets, different orientations relative to the plurality of targets, and/or different heights relative to the plurality of targets. For example, the vehicle computing system 112 can generate one or more control signals to move the autonomous vehicle 108 on which the one or more radar devices are attached; and/or a mounting stand to which the one or more radar devices are attached to the plurality of different positions relative to the plurality of targets. By moving the autonomous vehicle and/or the mounting stand to the plurality of different positions, the one or more radar devices attached to the autonomous vehicle and/or the mounting stand will also be moved to the plurality of different radar device positions.

At 904, the method 900 can include generating the plurality of radar detections at each of the plurality of different radar device positions. The plurality of radar detections generated at each of the plurality of different radar device positions can be determined and/or recorded. Any differences in the plurality of radar detections at each of the plurality of different radar device positions can be used to individually calibrate each of the plurality of radar devices.

For example, the vehicle computing system 112 can generate one or more control signals to activate and/or control the one or more radar devices and cause the one or more radar devices to generate the plurality of radar detections at each of the plurality of different radar device positions.

At 906, the method 900 can include moving the vehicle (e.g., autonomous vehicle) to one or more positions that align the one or more radar devices with the plurality of targets. In some embodiments, moving the autonomous vehicle can include rotating the autonomous vehicle. For example, the vehicle computing system 112 can control a turntable on which the autonomous vehicle (e.g., the autonomous vehicle 108) is located. The turntable can move the autonomous vehicle to the one or more positions so that one or more radar devices and/or one or more imaging devices that are mounted on the autonomous vehicle can be aligned with a plurality of targets. Movement (rotation) of the autonomous vehicle can result in the alignment of the one or more radar devices and/or the one or more imaging devices with different sets of the plurality of targets. In some embodiments, the one or more radar devices and/or the one or more imaging devices can be mounted on the front, rear, port, and/or starboard portions of the autonomous vehicle. Further, the autonomous vehicle can be moved so that a portion of the autonomous vehicle including the front, rear, port, and starboard portions of the autonomous vehicle are aligned with the plurality of targets.

FIG. 10 depicts a flow diagram of an example of radar validation and calibration according to example embodiments of the present disclosure. One or more portions of a method 1000 can be implemented by one or more devices (e.g., one or more computing devices) or systems including, for example, the operations computing system 104, the vehicle 108, the validation and calibration computing system 110, or the vehicle computing system 112, shown in FIG. 1. Moreover, one or more portions of the method 1000 can be implemented as an algorithm on the hardware components of the devices described herein (e.g., as in FIG. 1). In some embodiments, one or more portions of the method 1000 can be performed as part of the method 600 that is depicted in FIG. 6. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 1002, the method 1000 can include minimizing a detection cost associated with one or more configurations of the one or more radar devices and one or more differences between a plurality of expected target positions and corresponding detected target positions associated with the plurality of filtered radar detections. For example, as part of minimizing the detection cost, the vehicle computing system 112 can perform one or more calibration operations that include minimizing a residual associated with one or more differences between the plurality of target positions associated with the plurality of filtered radar detections and the plurality of target positions associated with an expected or actual target position (e.g., the actual position (distance and/or orientation) of a target relative to the position of a radar device).

At 1004, the method 1000 can include determining the detection error based at least in part on the detection cost. The detection error be associated with the detection cost (e.g., the detection error can have a predetermined relationship with the detection cost) such that, for example, a greater detection cost can be positively correlated with a greater detection error. For example, following determination of the detection cost, the vehicle computing system 112 can determine a detection error that uses the detection cost as the basis of a detection error (e.g., the value of the detection cost can be positively correlated with the value of the detection error) that corresponds to an offset value associated with configuration of the one or more radar devices. In some embodiments, the detection cost can be used as the basis for determining a detection error associated with one or more configurations of the one or more radar devices respectively including one or more yaw offsets of the one or more radar devices respectively.

FIG. 11 depicts a diagram of an example system according to example embodiments of the present disclosure. One or more operations and/or functions in FIG. 11 can be implemented and/or performed by one or more devices (e.g., one or more computing devices) or systems including, for example, the operations computing system 104, the vehicle 108, the validation and calibration computing system 110, or the vehicle computing system 112, which are shown in FIG. 1. Further, the one or more devices and/or systems in FIG. 11 can include one or more features of one or more devices and/or systems including, for example, the operations computing system 104, the vehicle 108, or the vehicle computing system 112, which are depicted in FIG. 1.

Various means can be configured to perform the methods and processes described herein. For example, a validation and calibration computing system 1100 can include one or more imaging units 1102, one or more radar detection units 1104, one or more filtration units 1106, one or more detection error determination units 1108, one or more calibration units 1110, and/or other means for performing the operations and functions described herein. In some implementations, one or more of the units may be implemented separately. In some implementations, one or more units may be a part of, or included in, one or more other units. These means can include one or more processors, one or more microprocessors, one or more graphics processing units, one or more logic circuits, one or more dedicated circuits, one or more application-specific integrated circuits (ASICs), programmable array logic, one or more field-programmable gate arrays (FPGAs), one or more controllers, one or more microcontrollers, and/or other suitable hardware. The means can also, or alternately, include software control means implemented with a processor or logic circuitry for example. The means can include or otherwise be able to access memory including, for example, one or more non-transitory computer-readable storage media, such as random-access memory, read-only memory, electrically erasable programmable read-only memory, erasable programmable read-only memory, one or more flash/other memory devices, one or more data registrars, one or more databases, and/or other suitable hardware.

The means can be programmed (e.g., an FPGA custom programmed to operate a computing system) or configured (e.g., an ASIC custom designed and configured to operate a computing system) to perform one or more algorithms for performing the operations and functions described herein. For example, the means (e.g., the one or more imaging units 1102) can be configured to determine, based at least in part on one or more imaging devices, a plurality of target positions for a plurality of targets. The plurality of targets can be located at a respective plurality of predetermined positions relative to the one or more imaging devices.

In some embodiments, the means (e.g., the one or more imaging units 1102) can be configured to determine, based at least in part on the first imaging device, a first set of positions of the plurality of targets.

In some embodiments, the means (e.g., the one or more imaging units 1102) can be configured to determine, based at least in part on the second imaging device, a second set of positions of the plurality of targets.

In some embodiments, the means (e.g., the one or more imaging units 1102) can be configured to cross-validate the first imaging device and the second imaging device based at least in part on one or more comparisons of the first set of positions to the second set of positions.

The means (e.g., the one or more radar detection units 1104) can be configured to generate, based at least in part on one or more radar devices, a plurality of radar detections of the plurality of targets. The one or more radar devices can be located at a predetermined position relative to the one or more imaging devices.

In some embodiments, the means (e.g., one or more radar detection units 1104) can be configured to position the one or more radar devices in a plurality of different radar device positions relative to the plurality of targets.

In some embodiments, the means (e.g., the one or more radar detection units 1104) can be configured to generate the plurality of radar detections at each of the plurality of different radar device positions.

In some embodiments, the means (e.g., the one or more radar detection units 1104) can be configured to move the autonomous vehicle to one or more positions that align the one or more radar devices with the plurality of targets. Moving the autonomous vehicle can include rotating the autonomous vehicle.

The means (e.g., the one or more filtration units 1106) can be configured to generate a plurality of filtered radar detections based at least in part on performance of one or more filtering operations on the plurality of radar detections.

The means (e.g., the one or more detection error determination units 1108) can be configured to determine a detection error for the one or more radar devices based at least in part on one or more calibration operations performed using the plurality of filtered radar detections and the plurality of target positions determined based on the one or more imaging devices.

In some embodiments, the means (e.g., the one or more detection error determination units 1108) can be configured to perform one or more optimizations of the plurality of target positions determined based on the one or more imaging devices and the plurality of filtered radar detections.

In some embodiments, the means (e.g., the one or more detection error determination units 1108) can be configured to minimize a detection cost associated with one or more configurations of the one or more radar devices and one or more differences between a plurality of expected target positions and corresponding detected target positions associated with the plurality of filtered radar detections.

In some embodiments, the means (e.g., the one or more detection error determination units 1108) can be configured to determine the detection error based at least in part on the detection cost.

The means (e.g., the one or more calibration units 1110) can be configured to calibrate the one or more radar devices based at least in part on the detection error.

In some embodiments, the means (e.g., the one or more calibration units 1110) can be configured to calibrate the one or more radar devices when the detection error satisfies one or more calibration criteria can include the detection error exceeding a maximum detection error threshold.

In some embodiments, the means (e.g., the one or more calibration units 1110) can be configured to adjust one or more positions of the one or more radar devices based at least in part on the detection error. Adjusting the one or more positions of the one or more radar devices can include adjusting a location of any of the one or more radar devices, adjusting a yaw offset of any of the one or more radar devices, adjusting a pitch offset of any of the one or more radar devices, or adjusting a roll offset of any of the one or more radar devices.

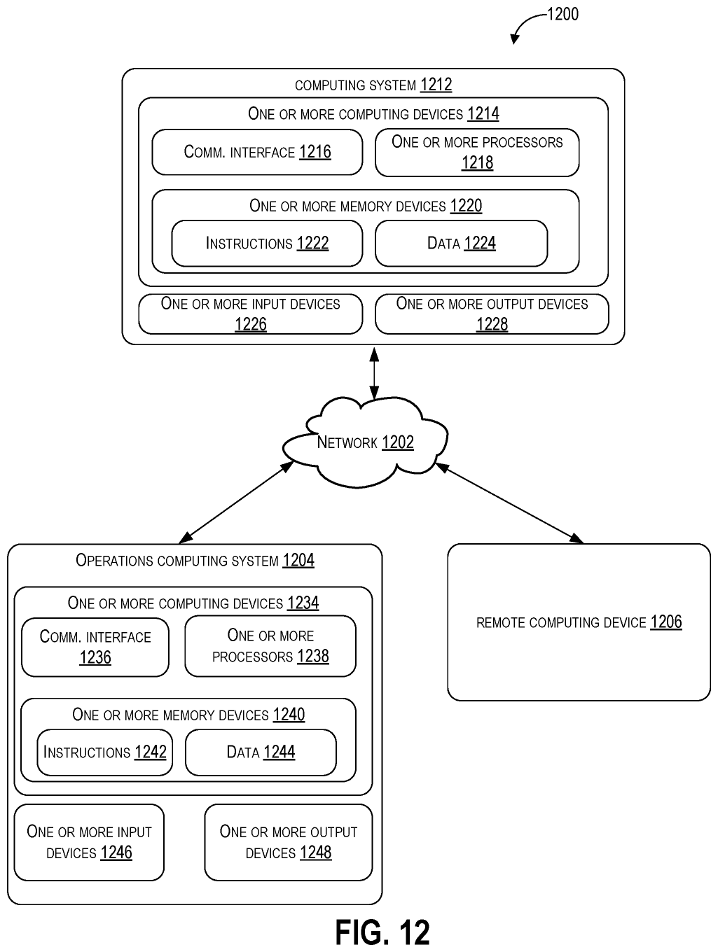

FIG. 12 depicts a diagram of an example system according to example embodiments of the present disclosure. A system 1200 can include a network 1202 which can include one or more features of the communications network 102 depicted in FIG. 1; an operations computing system 1204 which can include any of the attributes and/or capabilities of the operations computing system 104 depicted in FIG. 1; a remote computing device 1206 which can include any of the attributes and/or capabilities of the one or more remote computing devices 106 depicted in FIG. 1; a computing system 1212 which can include any of the attributes and/or capabilities of the vehicle computing system 112 depicted in FIG. 1; one or more computing devices 1214; a communication interface 1216; one or more processors 1218; one or more memory devices 1220; computer-readable instructions 1222; data 1224; one or more input devices 1226; one or more output devices 1228; one or more computing devices 1234; a communication interface 1236; one or more processors 1238; one or more memory devices 1240; computer-readable instructions 1242; data 1244; one or more input devices 1246; and one or more output devices 1248.

The computing system 1212 can include the one or more computing devices 1214. The one or more computing devices 1214 can include one or more processors 1218 which can be included on-board a vehicle including the vehicle 108 and one or more memory devices 1220 which can be included on-board a vehicle including the vehicle 108. The one or more processors 1218 can include any processing device including a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs), and/or processing units performing other specialized calculations. The one or more processors 1218 can include a single processor or a plurality of processors that are operatively and/or selectively connected. The one or more memory devices 1220 can include one or more non-transitory computer-readable storage media, including RAM, ROM, EEPROM, EPROM, flash memory devices, magnetic disks, and/or combinations thereof.

The one or more memory devices 1220 can store data or information that can be accessed by the one or more processors 1218. For instance, the one or more memory devices 1220 which can be included on-board a vehicle including the vehicle 108, can include computer-readable instructions 1222 that can store computer-readable instructions that can be executed by the one or more processors 1218. The computer-readable instructions 1222 can include software written in any programming language that can be implemented in hardware (e.g., computing hardware). Further, the computer-readable instructions 1222 can include instructions that can be executed in logically and/or virtually separate threads on the one or more processors 1218. The computer-readable instructions 1222 can include any set of instructions that when executed by the one or more processors 1218 cause the one or more processors 1218 to perform operations.

For example, the one or more memory devices 1220 which can be included on-board a vehicle (e.g., the vehicle 108) can store instructions, including specialized instructions, that when executed by the one or more processors 1218 on-board the vehicle cause the one or more processors 1218 to perform operations including any of the operations and functions of the one or more computing devices 1214 or for which the one or more computing devices 1214 are configured, including the operations described herein including operating an autonomous device which can include an autonomous vehicle.

The one or more memory devices 1220 can include the data 1224 that can include data that can be retrieved, manipulated, created, and/or stored by the one or more computing devices 1214. The data stored in the data 1224 can include any of the data described herein, including the sensor data, detection error data, data associated with one or more outputs of one or more imaging devices, data associated with one or more outputs of one or more radar devices, and any data associated with operation of an autonomous device which can include an autonomous vehicle. For example, the data 1224 can include data associated with an autonomy system of an autonomous vehicle including a perception system, a prediction system, and/or a motion planning system.

The data 1224 can be stored in one or more databases. The one or more databases can be split up so that the one or more databases are located in multiple locales on-board a vehicle which can include the vehicle 108. In some implementations, the one or more computing devices 1214 can obtain data from one or more memory devices that are remote from a vehicle, including, for example the vehicle 108.

The system 1200 can include the network 1202 (e.g., a communications network) which can be used to send and/or receive signals (e.g., electronic signals) or data (e.g., data from a computing device) including signals or data exchanged between computing devices including the operations computing system 1204, and/or the computing system 1212. The network 1202 can include any combination of various wired (e.g., twisted pair cable) and/or wireless communication mechanisms (e.g., cellular, wireless, satellite, microwave, and radio frequency) and/or any desired network topology (or topologies). For example, the communications network 1202 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from a vehicle including the vehicle 108.

The one or more computing devices 1214 can also include the communication interface 1216 used to communicate with one or more other systems which can be included on-board a vehicle including the vehicle 108 (e.g., over the network 1202). The communication interface 1216 can include any suitable components for interfacing with one or more networks, including for example, transmitters, receivers, ports, controllers, antennas, other hardware and/or software.

The computing system 1212 can also include one or more input devices 1226 and/or one or more output devices 1228. The one or more input devices 1226 and/or the one or more output devices 1228 can be included and/or otherwise associated with a human-machine interface system. The one or more input devices 1226 can include, for example, hardware for receiving information from a user, including a touch screen, touch pad, mouse, data entry keys, speakers, and/or a microphone that can be configured to detect and/or receive sounds in an environment and/or to be suitable for voice recognition.

The one or more output devices 1228 can include one or more display devices (e.g., organic light emitting diode (OLED) display, liquid crystal display (LCD), microLED display, or CRT) and/or one or more audio output devices (e.g., loudspeakers). The display devices and/or the audio output devices can be used to facilitate communication with a user. For example, a human operator (e.g., associated with a service provider) can communicate with a current user of a vehicle including the vehicle 108 via at least one of the display devices (e.g., a touch sensitive display device) and/or the audio output devices. Further, the one or more output devices 1228 can include one or more audio output devices (e.g., loudspeakers) that can be configured to generate and/or transmit sounds.

The operations computing system 1204 can include the one or more computing devices 1234. The one or more computing devices 1234 can include the communication interface 1236, the one or more processors 1238, and the one or more memory devices 1240. The one or more computing devices 1234 can include any of the attributes and/or capabilities of the one or more computing devices 1214. The one or more memory devices 1240 can store the instructions 1242 and/or the data 1244 which can include any of the attributes and/or capabilities of the instructions 1222 and data 1224 respectively.

For example, the one or more memory devices 1240 can store instructions, including specialized instructions, that when executed by the one or more processors 1238 on-board the vehicle cause the one or more processors 1238 to perform operations including any of the operations and functions of the one or more computing devices 1234 or for which the one or more computing devices 1234 are configured, including the operations described herein including determining, based at least in part on one or more imaging devices, a plurality of target positions for a plurality of targets; generating, based at least in part on one or more radar devices, a plurality of radar detections of the plurality of targets; generating a plurality of filtered radar detections based at least in part on performance of one or more filtering operations on the plurality of radar detections; determining a detection error for the one or more radar devices based at least in part on one or more calibration operations performed using the plurality of filtered radar detections and the plurality of target positions determined based on the one or more imaging devices; calibrating the one or more radar devices based at least in part on the detection error; and/or using the one or more calibrated radar devices to generate outputs that can be used as an input to an autonomy system of an autonomous vehicle that can be used as part of generating control signals that can be used to control devices and/or systems of the autonomous vehicle.

The one or more memory devices 1240 can include the data 1244 that can store data that can be retrieved, manipulated, created, and/or stored by the one or more computing devices 1234. The data stored in the data 1244 can include any of the data described herein including the sensor data, detection error data, data associated with one or more outputs of one or more imaging devices, and/or data associated with one or more outputs of one or more radar devices.

Furthermore, the operations computing system 1204 can include the one or more input devices 1246 and/or the one or more output devices 1248, which can include any of the attributes and/or capabilities of the one or more input devices 1226 and/or the one or more output devices 1228.

The remote computing device 1206 can include any of the attributes and/or capabilities of the operations computing system 1204 and/or the computing system 1212. For example, the remote computing device can include a communications interface, one or more processors, one or more memory devices, one or more input devices, and/or one or more output devices. Further, the remote computing device 1206 can include one or more devices including: a telephone (e.g., a smart phone), a tablet, a laptop computer, a computerized watch (e.g., a smart watch), computerized eyewear (e.g., an augmented reality headset), computerized headwear, and/or other types of computing devices. Furthermore, the remote computing device 1206 can communicate (e.g., send and/or receive data and/or signals) with one or more systems and/or devices including the operations computing system 1204 and/or the computing system 1212 via the communications network 1202. In some embodiments, the operations computing system 1204 described herein can also be representative of a user device that can be included in the human machine interface system of a vehicle including the vehicle 108.

The technology discussed herein makes reference to computing devices, databases, software applications, and other computer-based systems, as well as actions taken and information sent to and/or from such systems. One of ordinary skill in the art will recognize that the inherent flexibility of computer-based systems allows for a great variety of possible configurations, combinations, and divisions of tasks and functionality between and among components. For instance, computer-implemented processes discussed herein can be implemented using a single computing device or multiple computing devices working in combination. Data and/or instructions can be implemented on a single system or distributed across multiple systems. Distributed components can operate sequentially or in parallel.

Furthermore, computing tasks discussed herein as being performed at computing devices remote from the vehicle can instead be performed at the vehicle (e.g., via the vehicle computing system). Such configurations can be implemented without deviating from the scope of the present disclosure. The use of computer-based systems allows for a great variety of different possible configurations, combinations, and/or divisions of tasks and functionality between and/or among components. Computer-implemented tasks and/or operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1.-20. (canceled)

21. A computer-implemented method for cross-validating imaging devices, the method comprising:
determining, using an imaging device, a first set of positions of a plurality of targets;
determining, using a LIDAR device, a second set of positions of the plurality of targets; and
cross-validating the first imaging device and the second imaging device based at least in part on one or more comparisons of the first set of positions to the second set of positions.

22. The computer-implemented method of claim 21, wherein cross-validating the imaging device and the LIDAR device comprises:
comparing the first set of positions to the second set of positions to determine a difference between the first set of positions and the second set of positions indicative of an amount of imaging error between the first imaging device and the second imaging device; and
validating the LIDAR device based at least in part on the difference between the first set of positions and the second set of positions.

23. The computer-implemented method of claim 21, wherein cross-validating the imaging device and the LIDAR device comprises:
comparing the first set of positions to the second set of positions to determine a difference between the first set of positions and the second set of positions indicative of an amount of imaging error between the first imaging device and the second imaging device; and
validating the imaging device based at least in part on the difference between the first set of positions and the second set of positions.

24. The computer-implemented method of claim 21, wherein determining the first set of positions of the plurality of targets comprises:
causing the imaging device to capture one or more images of the plurality of targets; and
determining the first set of positions of the plurality of targets based at least in part on the one or more images of the plurality of targets.

25. The computer-implemented method of claim 21, wherein determining the second set of positions of the plurality of targets comprises:
causing the LIDAR device to capture one or more images of the plurality of targets; and
determining the second set of positions of the plurality of targets based at least in part on the one or more images of the plurality of targets.

26. The computer-implemented method of claim 21, wherein the first imaging device comprises a camera.

27. The computer-implemented method of claim 21, wherein the first set of positions comprises an orientation and a distance of at least one target of the plurality of targets from the imaging device; and wherein the second set of positions comprises an orientation and a distance of the at least one target of the plurality of targets from the LIDAR device.

28. The computer-implemented method of claim 21, wherein the plurality of targets comprises one or more fiducial images that identify a respective target of the plurality of targets and is encoded with information about the respective target.

29. The computer-implemented method of claim 21, further comprising:
subsequent to cross-validating the imaging device and the LIDAR device, determining, using the imaging device and the LIDAR device, a plurality of target positions of the plurality of targets; and
calibrating one or more sensors based at least in part on the plurality of target positions.

30. A computing system, comprising:
one or more processors; and
one or more non-transitory computer-readable media storing instructions that when executed by the one or more processors cause the one or more processors to perform operations comprising:
determining, using a first imaging device, a first set of positions of a plurality of targets;
determining, using a second imaging device, a second set of positions of the plurality of targets; and
cross-validating the first imaging device and the second imaging device based at least in part on one or more comparisons of the first set of positions to the second set of positions.

31. The computing system of claim 30, wherein the first imaging device has a different resolution from the second imaging device.

32. The computing system of claim 30, wherein the first imaging device is a different type of imaging device than the second imaging device.

33. The computing system of claim 30, wherein the first imaging device or the second imaging device is a LIDAR device.

34. The computing system of claim 33, wherein cross-validating the first imaging device and the second imaging device comprises:
validating the LIDAR device based at least in part on a difference between the first set of positions and the second set of positions.

35. The computing system of claim 30, wherein the first set of positions comprises an orientation and a distance of at least one target of the plurality of targets from the first imaging device, and wherein the second set of positions comprises an orientation and a distance of at least one target of the plurality of targets from the second imaging device.

36. The computing system of claim 35, wherein the first imaging device comprises a camera.

37. The computing system of claim 36, wherein cross-validating the first imaging device and the second imaging device comprises:
validating the camera based at least in part on a difference between the first set of positions and the second set of positions.

38. One or more non-transitory computer-readable media storing instructions that when executed by one or more processors cause the one or more processors to perform operations comprising:
determining, using an imaging device, a first set of positions of a plurality of targets;
determining, using a LIDAR device, a second set of positions of the plurality of targets;
determining a difference between the first set of positions and the second set of positions, wherein the difference between the first set of positions and the second set of positions is indicative of an amount of imaging error between the first imaging device and the second imaging device; and
cross-validating the first imaging device and the second imaging device based at least in part on the difference between the first set of positions and the second set of positions.

39. The one or more non-transitory computer-readable media of claim 38, wherein the first imaging device comprises a camera and the second imaging device comprises a LiDAR device.

40. The one or more non-transitory computer-readable media of claim 38, wherein the operations further comprise:
subsequent to cross-validating the first imaging device and the second imaging device, determining, using the first imaging device and the second imaging device, a plurality of target positions of the plurality of targets; and
calibrating the one or more sensors based at least in part on the plurality of target positions.
